(19) United States
(12) Patent Application Publication
(10) Pub. No.: US 2008/0005719 A1
(43) Pub. Date: Jan. 3, 2008

(54) METHODS, SYSTEMS, AND COMPUTER PROGRAM PRODUCTS FOR PROVIDING A PROGRAM EXECUTION ENVIRONMENT

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/428,273

(22) Filed: Jun. 30, 2006

(51) Int. Cl. G06F 9/44

(52) U.S. Cl. 717/100

(57) ABSTRACT

A method for program execution includes providing an execution environment for a program including a structured data storage system (SDSS) capable of accessing storage locations of a structured data store using corresponding logical identifiers. The data store is structured according to a schema known to the SDSS. The exemplary method allows an addressable entity of the program to be stored at a storage location of the data store associated with a corresponding logical identifier. The addressable entity is stored in conformance with the schema as a result of at least one of compiling a source code representation of the addressable entity, interpreting an intermediate code representation of the addressable entity, linking the addressable entity to other addressable entities, and loading the addressable entity into the execution environment. The exemplary method allows a processor executing a machine code instruction of the program to access the addressable entity using an address corresponding to the logical identifier as an instruction operand during execution of the instruction.

### RELATED APPLICATIONS

This application is related to U.S. patent application Ser. No. ______, titled “Methods, Systems, and Computer Program Products for Generating and Using Object Modules,” (Attorney Docket No. 1411), U.S. patent application Ser. No. ______, titled “Methods, Systems, and Computer Program Products for Providing Access to Addressable Entities Using a Non-Sequential Virtual Address Space,” (Attorney Docket No. 1374), and U.S. patent application Ser. No. ______, titled “Methods, Systems, and Computer Program Products for Using a Structured Data Storage System to Provide Access to Addressable Entities in Virtual Address Space,” (Attorney Docket No. 1427), each filed on even date herewith and assigned to the same assignee as this application, the disclosures of which are each incorporated here by reference in their entirety.

### TECHNICAL FIELD

The subject matter described herein relates to software programming tools and execution environments. More particularly, the subject matter described herein relates to methods, systems, and computer program products for providing a program execution environment.

### BACKGROUND

Conventional programming and scripting languages, and the tools that support them, allow developers to produce program machine code that can be loaded into virtual and/or physical memory, and executed by an associated processor. The memory address space recognized by a processor, both virtual address space and physical address space, is sometimes referred to here as processor address space or simply as address space. Conventional programming languages include syntax for generating source code, including object-oriented code, procedural code, intermediate code, artificial intelligence code, and other types of code. A compiler and a linker convert the source code into a representation referred to as object code. A loader loads the object code into memory and a load-time and/or a run-time linker may be used to resolve any unresolved references (e.g., symbols for addressable entities, such functions or variables, that are called or referenced by the loaded object, but are not internally defined) to allow execution of the program. The loader/linker's job is to resolve references to undefined symbols by finding out which other object defines a symbol in question, and replacing placeholders with the symbol's address.

Conventional execution environments that run object code generated by conventional programming languages and tools use sequential address spaces, where one address in the space follows another in sequence with the exception of the first and last address. Within these sequential address spaces, numerical addressing (e.g., using pointers and offset values) is used to reference and provide access to addressable content. This sequential, numerical addressing scheme creates an inviting environment for exploitation by malicious software programs. Because of the ease with which different regions of the processor address space of conventional execution environments may be mathematically calculated and accessed, security problems exist within these conventional execution environments. Exemplary security problems include the overwriting of program buffers and the use of pointer arithmetic to gain access to code and data, normally inaccessible that can then be manipulated.

Another disadvantage associated with conventional program development tools and execution environments is that programs must be re-linked and/or reloaded each time they are executed. There is no ability in current execution environments for an addressable entity of a program to be persistent or to persistently maintain static portions of a program in an execution environment between program instantiations.

Accordingly, in light of the difficulties associated with conventional programming tools and conventional execution environments, there exists a need for improved methods, systems, and computer program products for providing a program execution environment and for generating and using object modules.

### SUMMARY

According to an exemplary embodiment, a method for program execution includes providing an execution environment for a program including a structured data storage system (SDSS) capable of accessing storage locations of a structured data store using corresponding logical identifiers. The data store is structured according to a schema known to the SDSS. The exemplary method allows an addressable entity of the program to be stored at a storage location of the data store associated with a corresponding logical identifier. The addressable entity is stored in conformance with the schema as a result of at least one of compiling a source code representation of the addressable entity, interpreting an intermediate code representation of the addressable entity, linking the addressable entity to other addressable entities, and loading the addressable entity into the execution environment. The exemplary method allows a processor executing a machine code instruction of the program to access the addressable entity using an address corresponding to the logical identifier as an instruction operand during execution of the instruction.

According to another exemplary embodiment, a system for program execution includes a processor for executing instructions of a program. The exemplary system includes a structured data storage system (SDSS) operatively coupled to the processor. The SDSS is capable of accessing storage locations of a structured data store using corresponding logical identifiers. The data store is structured according to a schema known to the SDSS. The exemplary system also includes an execution environment adapted to use the SDSS for execution of the program by the processor. The execution environment allows an addressable entity of the program to be stored at a storage location of the SDSS associated with a corresponding logical identifier. The addressable entity is stored in conformance with the schema as a result of at least one of compiling a source code representation of the addressable entity, interpreting an intermediate code representation of the addressable entity, linking the addressable entity to other addressable entities, and loading the addressable entity into the execution environment. The execution environment also allows the processor, executing a machine code, instruction to access the addressable entity using an address corresponding to the logical identifier as an instruction operand during execution of the instruction by the processor.

According to yet an exemplary embodiment, a method for program execution includes providing an execution environment for a program including a non-sequential address space. An addressable entity of the program is allowed to be stored at a storage location of a data store associated with a corresponding logical identifier. The addressable entity is stored as a result of at least one of compiling a source code representation of the addressable entity, interpreting an intermediate code representation of the addressable entity, linking the addressable entity to other addressable entities, and loading the addressable entity into the execution environment. The exemplary method allows a processor executing a machine code instruction of the program to access the addressable entity using an address of the non-sequential address space corresponding to the logical identifier as an instruction operand during execution of the instruction.

According to still another exemplary embodiment, a computer-program instruction embodied in a computer-readable medium for execution within a program execution environment includes an operational code portion for instructing a processor to perform a predetermined operation and an operand portion including an address corresponding to a logical identifier for referencing an addressable entity stored at a storage location of a structured data storage system (SDSS) associated with a corresponding logical identifier. The addressable entity is stored in conformance with the schema as a result of at least one of compiling a source code representation of the addressable entity, interpreting an intermediate code representation of the addressable entity, linking the addressable entity to other addressable entities, and loading the addressable entity into the execution environment. The execution environment includes a SDSS capable of accessing storage locations of a structured data store using corresponding logical identifiers, the data store structured according to a schema known to the SDSS.

### BRIEF DESCRIPTION OF THE DRAWINGS

Preferred embodiments of the subject matter described herein will now be explained with reference to the accompanying drawings of which:

FIG. 1 illustrates an exemplary environment for executing programs according to an exemplary embodiment;

FIG. 2 is a flow chart illustrating an exemplary process for executing a program according to an embodiment of the subject matter described herein;

FIG. 3A illustrates an exemplary object file format that may be used for an object file suitable for loading into the execution environment shown in FIG. 1;

FIG. 3B illustrates an exemplary memory format associated with the loading of an object file having the format shown in FIG. 3A;

FIG. 4 illustrates an exemplary entity-relationship view depicting an exemplary storage layout an executable format of a program loaded into execution environment shown in FIG. 1;

FIG. 5 illustrates an exemplary data structure represented in “C” code that may be implemented within execution environment shown in FIG. 1;

FIG. 6 illustrates exemplary table entries that may be used to support instances of the data structure shown in FIG. 5;

FIG. 7 illustrates exemplary tables that may be used for function/subroutine (or code block) activation within the execution environment shown in FIG. 1;

FIG. 8 illustrates exemplary “C” source code from which addressable object entities may be generated and processed within the execution environment shown in FIG. 1;

FIG. 9A illustrates a first portion of exemplary tables that may be used to represent the addressable entities generated from the “C” source code illustrated in FIG. 8;

FIG. 9B illustrates a second portion of exemplary tables that may be used to represent the addressable entities generated from the “C” code illustrated in FIG. 8;

FIG. 10 is a flow chart illustrating an exemplary process for compiling program source code components according to an embodiment of the subject matter described herein;

FIG. 11 is a flow chart illustrating an exemplary process for linking addressable entities and corresponding references according to an embodiment of the subject matter described herein; and

FIG. 12 is a flow chart illustrating an exemplary process for loading a program addressable entity into a program execution environment according to an embodiment of the subject matter described herein.

### DETAILED DESCRIPTION

In view of the problems described above with respect to conventional programming tools (e.g., programming-language-specific compilers, linkers and loaders) and conventional program execution environments, the subject matter described herein provides for a program execution environment capable of supporting a non-sequential address space and/or an address space corresponding to a structured storage/memory space (referred to here as a “structured data store”) on a system using a conventional processor and memory management system (MMS). The structured data store can span both memory and secondary (or persistent) storage. The address space corresponding to the structured data store can be a non-sequential address space, a conventional sequential flat or segmented address space, in which addresses are respectively expressed as incrementally increasing integers starting at zero or as separate segments augmented by offsets, or a combination of both non-sequential and conventional sequential address space portions. As will be understood by those of ordinary skill in the art of processor design, the non-sequential and conventional sequential address spaces can include either physical or virtual addresses accessible to or reserved for a processor during program execution.

As described in greater detail below, the distinct storage and/or memory locations of the structured data store can be managed by what is referred to here as a “structured data storage system” (SDSS). A data storage location in the SDSS is structured according to a schema known to the SDSS. The storage locations are identifiable using logical identifiers, sometimes referred to here as SDSS identifiers, which are comparable to the addresses of conventional address spaces. The set of valid identifiers that may be associated with the storage locations is known as the SDSS identifier space or address space. The SDSS identifier space can be associated with storage space in both processor memory, such as random-access memory (RAM), and secondary (or persistent) storage. Thus, the SDSS identifier space and its associated storage space can span both processor memory and secondary storage. An SDSS may include software that executes on a hardware platform, such as a general purpose computing platform, to manage the storage locations of the data store.

The term SDSS is sometimes used here to encompass both the management software and the data storage that the software manages (e.g., “the storage locations of the SDSS”), but persons skilled in the art will understand that arrangements where these memory management components are integrated or implemented separately are each within the scope of the subject matter described. When used as an adjective describing an entity represented by a noun, the term “SDSS” indicates that the entity may be compatible with a non-sequential address space and/or an address space corresponding to a structured data store.

An SQL database management system (DBMS) that supports tables with unique names and records with identifiers, together with its underlying data storage, is an example of an SDSS for purposes of the description herein. Examples of other database management systems suitable for use with the subject matter described herein include relational database management systems, object oriented database management systems, and other DBMS-like systems, although a DBMS, per se, is not required. Indeed, many of the characteristics and features of existing database management systems are not required to support the program execution environment described here. Nevertheless, example uses of some of these characteristics and features of database management systems are described later as optional extensions.

Whereas conventional processor address spaces are sequential, largely contiguous, and numerical, the methods, systems, and computer program products described herein enable the use of a non-sequential, non-contiguous, and/or non-numeric address space under the control of an SDSS. Nevertheless, the techniques described here can be used in a mixed program execution environment having at least a portion of a program using the address space under control of an SDSS, with the remainder of executable code using the address space associated with a conventional program execution environment. By adapting software development tools and the program execution environment to use an SDSS, program security may be improved. Other advantages of an SDSS execution environment such as reduced loading and linking times and providing for persistent program addressable entities, are enabled regardless of the characteristics of the processor address space.

As used here, the term “program” refers to any data representation that can be translated into a set of machine code instructions (including the machine code instructions themselves) and any associated program data. Thus, a program may include, among other like entities, an application, a shared or non-shared library, and a system command. Program representations, other than machine code, can include object code, byte code, intermediate code, and source code.

The phrase “object code” is meant to include a set of program instructions and/or data elements that are either prepared for linking prior to loading, are loadable into an execution environment, or are loaded into an execution environment. When in an execution environment, object code may be fully linked or may contain one or more unresolved references. The context in which this term is used will make clear the state of the object code when relevant to do so. Object code, as used here, can include machine code and virtual machine code, including JAVA™ byte code. Consequently, the terms machine code, byte code, and object code are used here interchangeably.

The phrase “program addressable entity”, or simply “addressable entity,” is used herein to describe at least a portion of a program that is addressable within a compatible program execution environment. An addressable entity can include any portion of a program that can be assigned an address in the address space of the execution environment during a compiling, linking, interpreting, or loading of the program. Examples of addressable entities include variables including structures, constants including structured constants, functions, subroutines, methods, classes, anonymous scoped instruction sets, and individual instructions which may be labeled.

Typically, an addressable entity is realized as a storage entity that contains a value which may represent data or an instruction. The addressable entity is said to be assigned or contain the value and is not the value itself. Yet, in some instances, this document will use the phrase addressable entity in a manner that refers to the content or value of the entity. In these instances, the context will clearly indicate the intended meaning. Addressable entities may have a number of corresponding formats. These formats include source code, object code, and any intermediate formats used by an interpreter, compiler, linker, loader, or equivalent tool. Thus, terms such as addressable source code entity may be used in cases where the format is relevant and may be unclear from the context.

### SDSS Execution Environment

The phrase “SDSS execution environment” is used here to describe a program execution environment, or portion thereof, in which at least at least a portion of the execution address space, referred to as an SDSS identifier space (described below), is created and managed by an SDSS. As will be described in more detail below, to operate under the control of an SDSS execution environment, addressable entities may be stored in storage locations managed by the SDSS. These storage locations may be addressed using logical storage location identifiers, sometimes referred to here as SDSS identifiers. In contrast to conventional addressing, which uses conventional virtual and/or physical address schemes, an SDSS execution environment and its associated tools allow for the use of SDSS identifiers to locate addressable entities.

The phrase “SDSS identifier space” (or more simply, “identifier space”) is used herein to refer to a set of valid, logical identifiers that may be associated with structured storage locations of SDSS managed storage. The phrases “identifier space” and “address space” are sometimes used interchangeably to collectively represent the execution address space for a program, although typically the phrase “identifier space” will refer to those identifiers corresponding to SDSS storage locations, and the phrase “address space” will refer to a mixed identifier/address space, a portion corresponding to SDSS storage and another portion corresponding to conventional storage. Thus, the phrase “identifier space” can encompass those logical identifiers corresponding to storage locations in processor and/or secondary storage of an execution environment. The identifier space can be larger than the processor memory and/or secondary storage available for program execution. The portion of the identifier space corresponding to the processor memory and/or secondary storage that is available for program execution is sometimes referred to here as the “active identifier space.” Identifiers can transition from being inactive to active, and vice versa, during program execution. When referred to here simply as “identifier space,” it should be clear from the context of the written description whether an identifier included in the space referred to is active or not.

SDSS identifiers are referred to here as logical identifiers in the sense that the identifiers are not virtual or physical addresses of storage locations directly accessible by a processor, but instead logically represent storage locations that may be mapped to such addresses. An SDSS identifier does not have to be numeric and may be mapped within the SDSS to a storage location associated with a virtual/physical memory address of the underlying operating system and processor address space and/or to a storage location in persistent storage, such as a location in a hard disk drive or separate data store. An SDSS identifier may contain multiple parts, For example, in a DBMS-based SDSS arrangement, an SDSS identifier can include a DBMS host identifier, a DBMS name, a table identifier, a record identifier, and a column name or index. A set of SDSS identifiers may make up the addressable space for the SDSS execution environment. As mentioned above, this addressable space may be viewed as an SDSS identifier space. Compilers, linkers, and loaders may use the SDSS identifier space in preparing a program for execution within the SDSS execution environment. As used herein, the term “identifier” or “SDSS identifier” may refer to any portion of a complete SDSS identifier that enables an addressable entity to be located within the context of the processing of a program instance. For example, an identifier without a host identifier may refer to the local host. An identifier including only a record identifier may refer to the first column of a record in a table being used in the context of processing a set of instructions.

By using an SDSS to manage the storage and retrieval of addressable entities to/from storage locations corresponding to the SDSS identifier space and by using SDSS identifiers in the machine code to reference such storage locations, program loading and linking times may be minimized and, in some embodiments, need only be performed once. In addition, many programs, or static portions thereof, can be persistently linked and/or loaded in the SDSS execution environment. Allowing programs to be persistently linked and/or loaded into the execution environment and maintained in the environment between program instantiations can improve runtime performance for users, in addition to allowing for more efficient debugging and control of programs during execution. In addition, program instances may be maintained in the execution environment across reboots of a system. Thus, it is possible to instantiate a program and maintain the same instance indefinitely. This differs from current hibernation technologies that do not perform a reboot of the underlying system and, in some instances, may requiring re-linking when a hibernated image is loaded from persistent storage to processor memory.

For example, once a linker is run to resolve symbolic references in a program to corresponding SDSS identifiers, then programs may be moved from one virtual and/or physical processor memory address to another without requiring any updates to the SDSS identifier used for addressing entities referenced in the machine code for such programs. Similarly, when a program is moved from persistent storage to a storage location in processor memory, the corresponding SDSS identifiers in the machine code of the program do not need to be changed. The SDSS execution environment is capable of resolving identifiers to the corresponding addressable entity in the database regardless of the processor memory and/or persistent storage location of the addressable entity.

While a database management system is not required by the definition of an SDSS provided above, many types of database management systems may be used to implement embodiments analogous to the embodiments described given that they meet the definition of an SDSS. For example, a relational DBMS, a dimensional DBMS, a hierarchical DBMS, and an object-oriented DBMS may all be used, alone or in combination, to implement embodiments of the subject matter described herein. Many other DBMS types are available and all are considered within the scope of the subject matter described herein. Beyond the minimal requirements described above, additional features typically associated with a DBMS may be used to provide additional functionality to the program execution environment. For example, query support through a query language, is not required, but may be provided, adding additional functionality and benefit to the SDSS execution environment. Additional DBMS features, and their benefits, are discussed in more detail below.

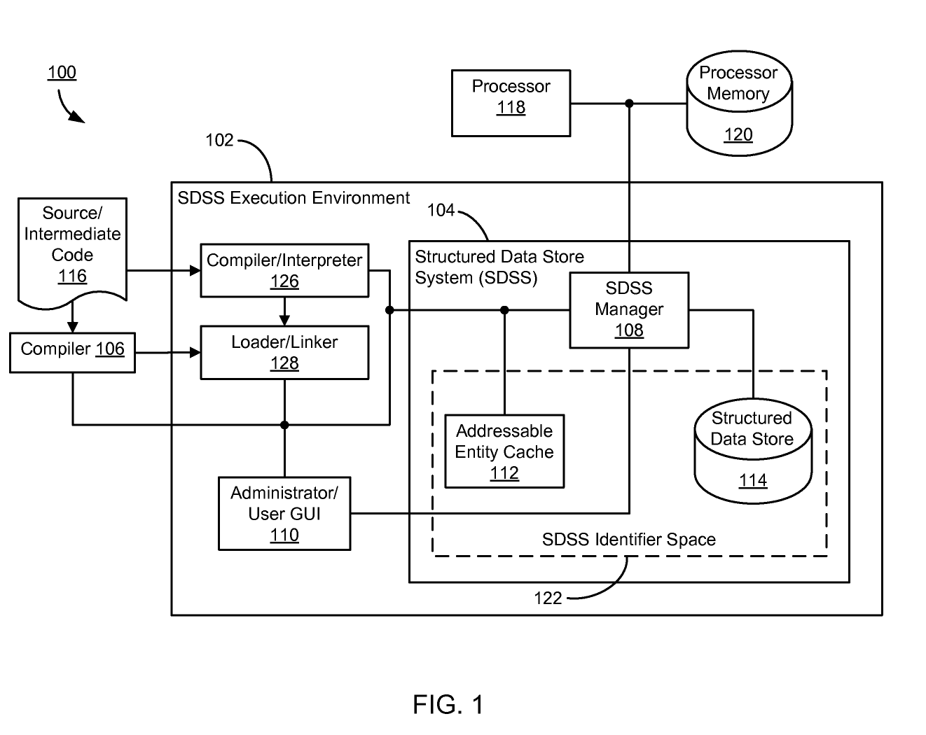

According to one aspect, the subject matter described herein includes a system for program execution. FIG. 1 illustrates an exemplary system 100 providing for executing programs using an SDSS execution environment. In the illustrated example, system 100 includes execution environment 102, including means for executing instructions of a program, such as processor 118 and processor memory 120. Processor memory 120 can store program instructions and data that are accessible to processor 118 for executing the instructions under control of an operating system as occurs in conventional execution environments. Execution environment 102 also includes means for allowing an addressable entity of the program to be stored at a storage location of a structured data store associated with a corresponding logical identifier. For example, execution environment 102 includes SDSS 104 and SDSS manager 108 that allow addressable program entities to be stored at storage locations of structured data store 114.

Execution environment 102 also includes memory access means for accessing the storage location of the structured data store using the corresponding logical identifier and means for allowing access to an addressable entity during execution of a machine code instruction having an address corresponding to the logical identifier as an instruction operand. For example, SDSS manager 108 allows processor 118, when processing a machine code instruction, to read a data value associated with an addressable entity stored in structured data store 114 and/or in addressable entity cache 112, write a data value to the stored addressable entity, or execute an instruction associated with the addressable entity. Each storage location available via SDSS 104 is associated with an SDSS identifier. As stated above, SDSS 104 may be any suitable structured environment for maintaining associations between SDSS identifiers and addressable entities. For example, SDSS 104 may be any combination of a relational, object-oriented, dimensional, and hierarchical-model DBMS, with corresponding underlying relational, object-oriented, dimensional, and hierarchical-model databases, without departing from the scope of the subject matter described herein.

Processor 118 is operatively coupled to SDSS 104 via SDSS manager 108, which can maintain an addressable entity cache 112 (described in greater detail below). Together, the SDSS identifiers corresponding to storage locations associated with addressable entity cache 112 and structured data store 114 form the active SDSS identifier space 122 for supporting program execution within execution environment 102. Consequently, SDSS identifier space 122 can also be considered as structured according to a schema known to SDSS manager 108, for purposes here. Processor 118 can also access processor memory 120 via a memory management unit (MMU, not shown) included in processor 118, similar to arrangements in conventional execution environments. Thus, the address space available to processor 118 for programs executing within the system 100 can include both SDSS identifier space 122, available via SDSS manager 108, and the processor address space available directly via a conventional memory management system including the MMU of processor 118.

As described above, an SDSS addressable entity can include any portion of a program that is assigned an address in SDSS identifier space 122 during a compiling, linking, interpreting, or loading of the program. For example, the addressable entity may be a data construct addressable entity, e.g., an addressable entity of a constant, variable, structure, class, or function. The association between the addressable entity and the SDSS identifier may be generated during a compiling of a source code representation of the addressable entity included in program source code 116 via compiler 106. Alternatively, the association can occur during an interpreting of a source or intermediate code representation of the addressable entity via compiler/interpreter 126. Association can also occur when linking the addressable entity to other addressable entities or when loading the addressable entity into execution environment 102 via linker/loader 128. The arrows shown in FIG. 1 illustrate the flow of source and/or intermediate code through the various functions of compiling, linking, and loading addressable entities.

Associations between references using addressable entity symbols and addressable entities within a loadable object file can be resolved prior to loading object code into an execution environment. Associations between references using addressable entity symbols within a loadable object to addressable entities in a second object file are resolved at load-time or run-time by using a symbol to determine the SDSS identifier of an associated addressable entity and using the SDSS identifier to resolved the reference. At least a portion of an SDSS identifier can be assigned prior to loading an addressable entity in some embodiments by at least one of a compiler, linker, or interpreter with the remaining portion assigned at load-time or run-time. The compile, link, and load functions may be performed via components internal to execution environment 102, e.g., via compiler/interpreter 126 and loader/linker 128. Alternatively, the compile, link, and load processes may be performed via components external to the execution environment 102, such as compiler 106 or a loader/linker (not shown) operating in an execution environment other than execution environment 102.

SDSS manager 108 may be operatively coupled to processor memory 120, compiler 106, compiler/interpreter 126, and/or loader/linker 128. SDSS manager 108 may create, in cooperation with compiler 106, compiler/interpreter 126, and/or loader/linker 128, associations between SDSS identifiers and addressable entities available via SDSS manager 108, and store and maintain these associations for use during program execution. SDSS manager 108 may also allow processor 118 to access addressable entities stored in storage locations associated with SDSS identifier space 122 using addresses corresponding to SDSS identifiers as instruction operands when processing machine code instructions. Some or all of the functionality of SDSS manager 108 can be implemented with a DBMS integrated with structured data store 114 and addressable entity cache 112 or can be a program component, separate from structured data store 114 and addressable entity cache 112, operating under control of an operating system.

For example, in providing an operand for a jump (or JMP) machine code instruction, rather than providing a physical or virtual address as the operand of the instruction based on knowledge of a conventional storage layout, SDSS manager 108 may provide an SDSS identifier associated with the storage location of an addressable entity referenced by the instruction (e.g., the target for the JMP) as the operand for the instruction. Alternatively, SDSS manager 108 may determine a processor memory address corresponding to the location of a storage location associated with an SDSS identifier and provide the determined processor memory address as an operand of the instruction at load-time or run-time.

SDSS manager 108 can maintain addressable entity cache 112 for maintaining structured processor memory representations of addressable entities, stored in SDSS identifier space 122, for processing by processor 118. Addressable entity cache 112 may contain portions of identifier space 122 referencing code and data (e.g., addressable entities) that is currently being used by a program being processed by processor 118. Although addressable entities may be physically cached in processor memory 120, logically, addressable entity cache 112 may be considered to be within identifier space 122 of SDSS 104, and thus a part of SDSS 104. As used herein, when an addressable entity is said to be stored in, or at a storage locations within, SDSS 104 or SDSS environment 102, the addressable entity may be stored in storage locations in addressable entity cache 112 referenced by SDSS identifiers, and thus can be cached or stored in processor memory 120, in storage locations of structured data store 114, or both.

In conventional execution environments a program component may contain unresolved references prior to loading, at load time, and during execution. Unresolved references are resolved by applying so-called “fix-ups” performed during the compile, link, and load processes associated with program execution. The phrase “fix-ups,” in conventional environments, refers to updates to object code that replace symbolic references with processor memory addresses, which may be either complete addresses or partial addresses, such as an address offset. Compilers are typically able to perform address resolution within a single compilation module. Unresolved references in an object module produced by a compiler are represented with symbolic references. A linker may combine two or more object modules into a loadable object module by “fixing-up” the symbolic references in each module with matching addressable object entities in other object modules being linked. Some unresolved reference may exist in a loadable object module. When an object file is loaded into memory, a dynamic linker may replace any remaining symbolic references with a virtual or physical address for the location where a matching addressable entity associated with the symbolic reference is located when loading the object module. In conventional systems, this dynamic linking during the loading of object modules is typically required for each instantiation of a program into the execution environment.

In contrast to conventional execution environments, execution environment 102 may monitor, e.g., via SDSS manager 108, access to addressable entities based on the processing performed by compiler 106, compiler/interpreter 126, and loader/linker 128. Addressable entities may be referenced through SDSS storage identifiers. Accordingly, once linked, program object code linking during run-time is reduced and, in some cases, may not be required at all. In contrast, virtually all current programs require at least some linking when loaded into the execution environment. Additionally, once a program is loaded and linked, it may remain in secondary storage of SDSS 104 after execution of the program is finished persisting through reboots.

Accordingly, a loaded program may remain loaded and linked indefinitely and may be moved between addressable entity cache 112 and secondary storage associated with SDSS 104, such as that provided by data store 114, without re-linking. When the program is run again, execution may begin more quickly because the program does not have to be reloaded and re-linked. The arrangement also allows a program instance to run indefinitely, even through a rebooting of the system 100. For example, addressable entities of a program instance may be swapped out to secondary storage prior to shutdown, and then moved to storage locations associated with their SDSS identifiers in addressable entity cash 112, in processor memory 120 by SDSS manager 108 to continue program execution after restart of the system 100. Again, reloading and re-linking of the program into the execution environment 102 may be unnecessary or the time required to do so may be reduced.

SDSS manager 108 may support query processing and indexing, e.g., via an administrator/graphical user interface (GUI) 110. For example, SDSS queries may be constructed to produce reports related to a program, its addressable entities, and related programs. SDSS manager 108 may provide application programming interfaces (APIs) to allow applications executed by processor 118 to access addressable entities maintained by SDSS 104. SDSS 104 may also provide support for scripting languages or any other languages seeking access to SDSS identifier space 122. User interfaces may be used to manage loaded and linked programs, instances of each program, and each instance's addressable entities. Further, the use of memory-mapped data stores may enhance performance, and distributed SDSS systems, such as a distributed DBMS, may allow loaded and linked programs to be stored across a distributed network of SDSS systems. As stated earlier, these features are optional and provide extended functionality available through the execution environment 102.

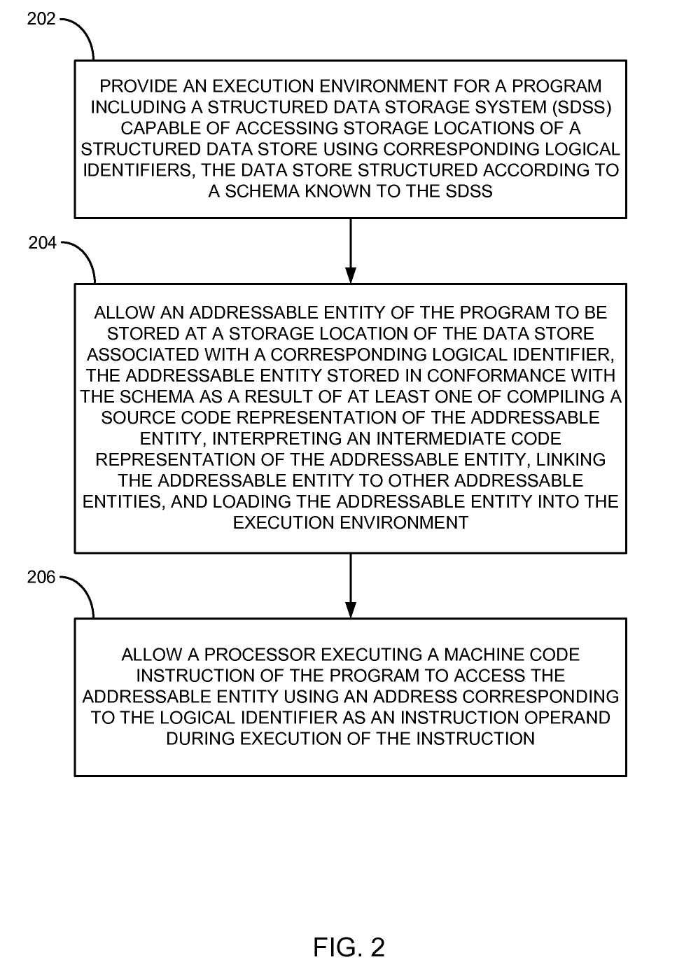

FIG. 2 illustrates an exemplary process for executing a program with an addressable entity stored within an SDSS execution environment. Referring to FIG. 2, in block 202, the process may provide an execution environment for a program including an SDSS capable of accessing storage locations using corresponding SDSS identifiers. For example, execution environment 102 may be provided including SDSS 104 capable of accessing storage locations corresponding to SDSS identifier space 122 including addressable entity cache 112 and structured data store 114 using corresponding SDSS identifiers.

At block 204, the process may allow an addressable entity of the program to be stored at a storage location of SDSS 104 associated with a corresponding SDSS identifier as a result of at least one of compiling of a source code representation of the addressable entity, interpreting of an intermediate code representation of the addressable entity, linking of the addressable entity to another addressable entity, and loading of the addressable entity into the execution environment. For example, SDSS 104 may allow an addressable entity to be stored at a storage location associated with a corresponding SDSS identifier. The addressable entity is stored in conformance with a schema associated with addressable entity known to data store 114 as a result of at least one of compiling of a source code representation of the addressable entity, interpreting of an intermediate code representation of the addressable entity, linking of the addressable entity to other addressable entities, and loading of the addressable entity into the SDSS execution environment 102.

At block 206, the process may allow processor 118 executing a machine code instruction to access the addressable entity using the SDSS identifier as an instruction operand, or using a processor address corresponding to the SDSS identifier as an instruction operand, during execution of the instruction. The instruction may be at least a portion of an addressable entity addressable from within SDSS identifier space 122 or may be in processor memory 120 under control of a conventional MMS.

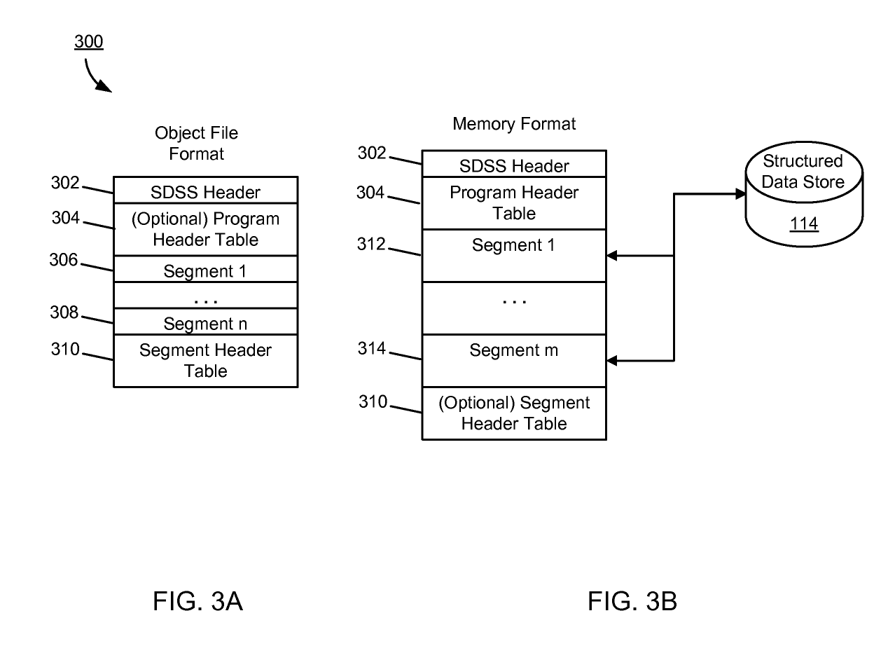

FIG. 3A illustrates an exemplary SDSS object file format 300 that may be used for an SDSS object file. SDSS object file format 300 may be generated by compiler 106 or compiler/interpreter 126 when creating an object file representation of source code 116. After creation of an object file using SDSS object file format 300, the resulting object file may be loaded into SDSS 104 and may be linked, if needed in execution environment 102 via loader/linker 128.

SDSS object file format 300 may be a combination of an existing object file format, such as executable and linking format (ELF), for elements loaded directly to processor memory 120 (e.g., virtual or physical memory) for processing, as occurs in conventional execution environments, and may also include extensions with instructions for SDSS manager 108 that specify types, create data instances, create code block instances, provide for linking, and provide other functionality. For example, when SDSS 104 includes a SDSS manager 108 which supports structured query language (SQL) such as an SQL DBM, SDSS object file format 300 may support one or more segments containing SQL instructions for implementing the operations described above. An object file using object file format 300 may be processor specific for object code instructions or the instructions may be expressed as byte-code (e.g., Java) that is compiled or interpreted to machine code at load-time or during execution.

In FIG. 3A, an SDSS header 302 is shown. SDSS header 302 may provide information related to the content of SDSS object file format 300, but can provide information relating to portions of the object file that are loaded in processor memory 120, as occurs in conventional execution environments. A program header table 304 is illustrated and serves the role it plays in ELF and other common object file formats. A segment 1 306 through a segment N 308 are illustrated and may include segments known as code segments, data segments, symbol tables, and other segment types found in ELF and other common object file formats. Additionally, at least a portion of segments 1 306 through segment N 308 contain information enabling at least a portion of addressable entities in the object file to be loaded into SDSS 104, and are referred to here as SDSS segments. SDSS segments allow a loader, such as loader/linker 128, to use SDSS manager 108 in the execution environment 102 to store program addressable entities in SDSS storage locations, such as those included in data store 114 and addressable entity cache 112, associated with an SDSS identifier. A segment header table 310 may be used to identify contents and information related to segment 1 306 through segment N 308 of SDSS object file format 300.

Alternatively, SDSS object file format 300 may be targeted to a homogenous SDSS execution environment, in which case all data and code may be stored in SDSS 104 of execution environment 102. All program instructions and data may be executed and accessed, respectively, under the control of execution environment 102 using SDSS-managed storage (e.g., persistent and/or in processor memory). The object file format for a homogenous SDSS execution environment may be as simple as a file of commands the loader uses to load the addressable entities and associated data, such as symbols, into SDSS 104 of execution environment 102. For example, if SDSS manager 108 is an SQL database manager, the object file may be an SQL script. SQL scripts, unlike traditional object files, are user-readable and editable files. A user may edit the SDSS object file in this format to change many aspects of the program without changing the original source code, and may add support for features not support by the original source language.

An exemplary SDSS object file loaded using an SQL database may contain SQL commands, such as commands that create symbol entries in a symbol table associated with addressable entities that are exportable and symbols associated with unresolved references that require linking. Optionally, symbol table entries may be created for additional, or all, addressable entities. These symbols may be required by other SDSS features beyond the minimum described, or may be provided for usability enabling an easier to navigate user interface 110 for a user. Symbols may also be enabled for debugging and logging.

The exemplary SDSS object file may also include commands that enable the creation of type tables. Type tables may be used for allocating program storage typically allocated out of traditional heap space.

For scoped sets of instructions such as functions, subroutines, and methods, referred to as “code blocks” in this document, commands that create tables for holding information associated with each instance of a function, subroutine, method, or other scoped code block may be included in the SDSS object file. The tables are referred to here as code block instance tables. Commands that add the machine code instructions for each code block to a storage location may also be included in the SDSS object file. In a preferred embodiment one record in one table, referred to as a code block table, may be allocated for each scoped code block, and may store the machine code instructions of the associated scoped code block.

Code blocks may be identified as static, meaning that only one record in an associated code block instance table may exist for a program instance or for all program instances. Alternatively, multiple code block instances may be created resulting in multiple records being created in a code block instance table associated with a single code block record. Commands that create and/or initialize constants and static data may be included in the SDSS object file as well. Other SDSS types would support object files that contain information enabling an analogous set of commands to be invoked by a loader to create a functionally analogous set of SDSS storage locations.

Some or all of the tables and data described above may be kept on a per process basis, may be kept in distinct database instances, or may be stored in tables shared by at least a portion of program instances and processes. Alternatively, global tables may be used for some or all of the addressable entities and associated data. The choice to share tables or keep table sets separated may vary with the overall system implementation

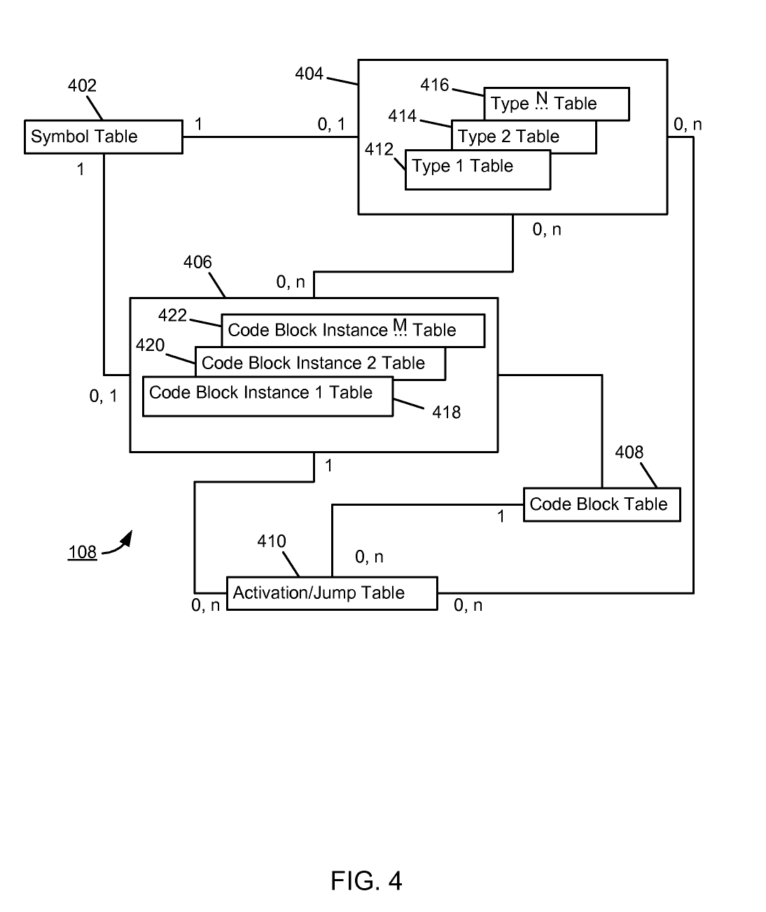

FIG. 3B illustrates an exemplary memory format associated with the loading of SDSS object file format 300, described in conjunction with FIG. 3A, that may be used for loading an SDSS object file in an execution environment using processor memory 120 outside of the execution environment 102 for storing at least a portion of the object code and execution environment 102 using SDSS 104 for storing another portion of the object code. A segment 1 312 through segment M 314 replace segment 1 306 through segment N 308 described in association with SDSS object file format 300 shown in FIG. 3A. Segment 1 312 through segment M 314 may reference code and data regions stored in processor memory 120. An exemplary set of SDSS commands, such as those previously discussed may be used by loader/linker 128 to load the SDSS portion of the object file into SDSS 104in execution environment 102. An exemplary storage layout is depicted in FIG. 4 and described later in this document.

A program compatible with execution environment 102 in the form of an object file may include a type area, a code area, a code block instance area, a constants area, and a symbol area in an embodiment of the described system and method. The type area may contain type information including schema information enabling schemas to be created for each specified type. Storage locations may be allocated conforming to the schemas and associated with various addressable entities using SDSS identifiers. The code area may contain object code information enabling storage to be allocated within SDSS 104for each addressable object code block entity. The code block instance area may contain code block instance information enabling schemas to be specified and storage locations allocated conforming to the schemas for addressable instance data entities for each addressable code block entity. The constants area may contain constant data enabling each constant specified to be to allocated and initialized in accordance with associated schemas created based on information associated with constant object addressable entities in the object file. The symbol area may contain information associated with addressable entities that may be available to other object code modules and information associated with addressable entities contained in other object code modules, which may be used by a linker for symbol resolution.

Regarding symbolic resolution within execution environment 102, symbols associated with more than one addressable entity within execution environment 102 may be supported just as in current execution environments. Symbols with top-level references within a program may be categorized as either strong or weak. Strong symbols may be considered global symbols that should be defined only once within a program. Weak symbols may be global in scope but may be allowed to be defined more than once within a program. For example, a weak symbol may be stored in the same manner as other global symbols but marked as weak in a column in each data and function table or storage schema. If other weak symbols with the same name are encountered during the loading of an object file, the weak symbols may be combined. Accordingly, the same record may be associated with each symbol. Similarly, if a global symbol with the same name is found, it may be associated with the same record. Two global symbols with the same name may generate a load/link error.

FIG. 4 illustrates an exemplary SDSS entity-relationship view of an embodiment of SDSS 104 for use in execution of programs developed and loaded into execution environment 102 with the use of the complier, linker, and loader functions of compiler 106, compiler/interpreter 126, and loader/linker 128 (collectively SDSS development tools). FIG. 4 may be viewed as a storage layout or high-level schema of an executable format of a program loaded into SDSS 104. This storage layout is at a higher level than a traditional memory storage layout, and supports an identifier space that is mapped to processor memory and/or to secondary storage. A program compiled, linked, or loaded to interoperate with SDSS 104 supporting the exemplary entity-relationship view depicted in FIG. 4 may access addressable entities by table identifier, record identifier, and (optionally) column identifier.

Linking may be performed by assigning SDSS identifiers or processor addresses based on SDSS identifiers (e.g., table and record identifiers and column identifiers when used), rather than by performing conventional processor address “fix-ups”. Accordingly, once code is “linked,” SDSS records may be moved in memory without corrupting the links. The associations of processor memory addresses with the links may be changed without requiring a re-linking operation for the code. Code within SDSS 104 may be relocated even if the source language does not support relocation of code. Alternatively, non-re-locatable data and code may be provided without departing from the scope of the subject matter described herein.

An SDSS symbol table 402, a plurality of type tables 404, a plurality of code block instance tables 406, a code block table 408, and an activation jump table 410 are illustrated in FIG. 4. Each will be described in more detail below. Further, within type tables 404, a type 1 table 412, and a type 2 table 414 up to a type N table 416 are illustrated. These type tables may provide storage for addressable data entities of different data types that are defined and accessible within SDSS 104. Within code block instance tables 406, a code block instance 1 table 418, and a code block instance 2 table 428 up to a code block instance M table 422 are illustrated. Each code block instance table may provide storage for addressable data entities for use by a corresponding record in the code block table 408, which provides storage for an addressable code block entity or a reference to an addressable code block entity typically located in processor memory 120. That is, a code block instance table 418-420 is associated with a function, method, subroutine, or other addressable set of machine instructions either referenced or contained in a column of a record in a code block table 408. Each record in a code block instance table 418-420 corresponds to an instance of the code block record in the code block table 408. A code block instance table 418-420 record may provide storage for input and/or output parameters, instance variables, constants, static and/or global variables, and a return result as needed by the associated code block table 408 record.

That is, a code block instance table 418-420 record provides storage for addressable data entities for use with a set of machine instructions much as a stack frame does in a conventional execution environment. The instance record may store values and/or references to values depending on implementation needs and requirements of the associated code block table 408 record. Alternately, static, global, and constant data may be stored in code block table 418-420 instance records associated with the current code block table 418-420 instance much like stack frames in a call sequence are related, or they may be stored in type tables and used directly with the machine instructions associated with the code block table 408 record. The associated code block table 408 record either references or contains the machine instructions for the function, method, subroutine, or other addressable code block entity based on instructions in the source code from which it is generated.

SDSS symbol table 402 may include all symbols associated with addressable entities, which may include references to imported entities, exported entities, weak entities, static variables, instance variables, constants, and machine code entities. SDSS symbol table 402 may include properties associated with each symbol as well such as the scope of the symbol. For example, records may be included within SDSS symbol table 402 for undefined symbols waiting to be resolved. Records may be included within SDSS symbol table 402 for data type symbols which are linked to an associated type table and which may further include columns indicating other attributes associated with the data type symbols such as scope and type.

Records may be included within SDSS symbol table 402 for code block symbols which are linked to an associated code block instance table and which may further include columns indicating other attributes associated with the code block symbols such as whether the symbol is exportable. Records may be included within SDSS symbol table 402 for data variable or constant symbols which may be associated with a column in an associated type table or code block instance table, such as type table 1 412 and code block instance 1 table 418, respectively. SDSS symbol table 402 may be implemented as one or more tables or storage locations without departing from the scope of the subject matter described herein. In fact, the set of tables shown may be implemented globally, on a per program basis, on a per process basis, or the SDSS may be segmented in other ways much as conventional processor memory models are segmented.

A type table within type tables 404, such as type 1 table 412, may be created for each addressable entity data type created by any of the SDSS execution environment development tools described above. Base types may be defined by SDSS 104 or SDSS manager 108, which may be assigned to table columns to specify the type of the addressable entity data stored in each column within SDSS 104 as indicated by the table's schema. An addressable entity of a structured type may span several tables. Each record in a type table may correspond to an addressable entity variable or constant instance. Variable instances may be allocated during execution and may be viewed as analogous to heap variables in traditional stack execution environments. The type tables 404 may include temporary variables created by machine instructions generated using any of the SDSS execution environment development tools. A record in an addressable entity type table may be associated with a code block table 408 record for an addressable code block entity, such as a record of code block table 408, for example, when the record in the type table serves as an addressable constant, global, or static entity and may be used by the code in the code block table record through a resolved reference.

A code block instance table 418-420 within code block instance tables 406, such as code block instance 1 table 418, may be created for each addressable code block instance entity (e.g., a function or subroutine). Tables may be provided for instances of private or anonymous code blocks, such as while loops, or such code blocks may be managed by the code block instance table 418-420 associated with the containing function, subroutine, or method. Each record in a code block instance table 418-420 may correspond to an instance or invocation of the machine code contained in, or referenced by, a code block instance table's 418-420 associated code block table 408 record. The record may enable a program instance or its associated machine code block to use parameter data and instance data, may provide storage for returned data, if any, and may provide access to global and static variables and data declared outside the code block instance that is referenced in the code block.

A code block instance table 418-420 record may be made available to its associated machine code instructions in a number of ways. For example, a code block instance table 418-420 record may be made available through a register containing the record identifier or a processor address corresponding to the record identifier associated with the record's storage location. Further, both the table identifier and record identifier or a complete SDSS identifier may be provided in the register without departure from the scope of the subject matter described herein.

A reference may be provided in the code block instance table record for a program's “main” code block instance record to enable access to static data and global data in a second method for providing access to static and global data. A “main” code block is the first or root code block invoked for a program instance. In “C”, the first code block invoked for a program instance must be named “main”, hence the name “main” is used to describe such first code blocks throughout this document. Alternatively, access to static and global data may be provided through an activation table record link within activation/jump table 410, where the first record for a program instance references the “main” code block instance. When the code block instance record is for the “main” code block of the program, no link to the static, global, and constant instance record may be needed, because the instance record for the “main” program may provide this capability for the other code block instances within execution environment 102. References to code block instances that may be called or jumped to will be discussed below in association with activation/jump table 410. A record within a code block table, such as code block table 408, may be created for each code block referenced within code block instance tables 406. That is, there may be a one-to-one relationship between code block instance tables and code block table records in the embodiment described.

A program's object file may be formatted to place the machine instructions for each code block in an SQL command, which may then be executed to create a record for a code block in code block table 408. Accordingly, the code may be stored as a column in a record within code block table 408 and may be accessed via its record. The code may be executed from the record under the control of execution environment 102. Each code block instance table within code block instance tables 406 may be linked to a record in code block table 408. This may be done through the metadata or a schema associated with code block instance table 418-420 or through the symbol table 402, for example, through a reference in the symbol table record associated with the addressable code block entity record in the code block table 408. Alternately, an addressable code block entity in an object file may be loaded into conventional processor memory under control of a conventional MMS rather than into a code block table 408 record.

Each record in code block table 408 may include an identifier and a conventional processor address allowing the associated machine code to be located in processor memory 120 rather than in SDSS 104. These two alternatives represent models that may be mixed with some code running within execution environment 102 and SDSS 104, and some code running within a conventional execution environment and processor memory 120. It should be noted that code stored in a code block table, such as code block table 408, may be relocated in processor memory 120, but, as described above, this relocation may be performed without any re-linking or “fix-up” at the processor address level when the record is relocated in some embodiments. This is possible because linking takes place through SDSS identifiers as will be described in more detail below.

An entry within an activation/jump table, such as activation/jump table 410, may be created for each activation (e.g., call) of a function or subroutine and each jump to an addressable instruction may result in a record being created within activation/jump table 410. A record in this table may reference the caller and callee code block instance table records within code block instance tables 406. The callee's code block instance table may allow the two code block instances to exchange data. Activation/jump table 410 record and the callee's code block instance table record may serve purposes analogous to the purposes served by a stack frame created by a function or subroutine call in stack-based conventional execution environments.

This method of associating a record within activation/jump table 410 with two code block instance tables within code block instance tables 406 has a number of advantages over stack-based conventional systems, as described above. For example, the space used by code block instance records and activation table records is not constrained in the same manner that stack space is constrained in conventional execution environments. Alternatively, information associated with a call operation may be placed in the code block instance tables for each of the caller and callee. Accordingly, an activation table may be omitted in such a situation. An exemplary embodiment without an activation table will be described below.

Based upon the description above, the table(s) used in creating an executable representation of a loadable object file may serve as a template(s) for a program's addressable entities including instance entities and global/static entities. Each addressable entity is an instance, and thus may be provided with a storage location for data that is independent of the storage location and data provided to other addressable entities of the same type. For example, the main code for a program may be associated with a code block instance table just as each code block instance table may be associated with a code block table record. Code block instance tables may be associated with “main” program code and may be identified to indicate that they are application execution starting points. Accordingly, main code block instance tables may be created within code block instance tables 406 to accommodate main code block instance records. The data in or referenced by a main code block instance table record may include an application's global and static data. Each invocation of a program would have its own main code block instance record in the main code block instance table.

Library modules may have global and static data as well. Accordingly, a library code block instance table may also be created for each library within code block instance tables 406 to enable records in these tables to hold global and static data for each instance of the library modules. When a new instance of a library or a program is to be created, the system may create a record in the library code block instance table and optionally set initial data values based on the table's schema and initialization information which may be a part of the schema or may be stored in an associated symbol table record. Information in the loadable object file may be used to create records and set initial values and relationships for addressable data entities stored in type tables within type tables 404. References between code block instance tables records and type tables records may be set up as well, either through direct links in the code block table record for static data or through an associated code block instance table record for instance data.

Fix-ups for static and instance data unresolved symbols may include partial SDSS identifiers because the references may be used to instantiate multiple instances of the associated addressable entities. Accordingly, identifiers may include offsets into an SDSS code block instance record corresponding to at least a portion of the instance record's SDSS identifier or may include a relative identifier for the column in a code block instance record. When an instance is executing, a register may be used to point to the record for the instance. The register may contain a at least a portion of an SDSS identifier, for example, a table identifier and a record identifier. A relative column identifier may then be used in association with the register contents to allow access to the proper entity for the executing instance.

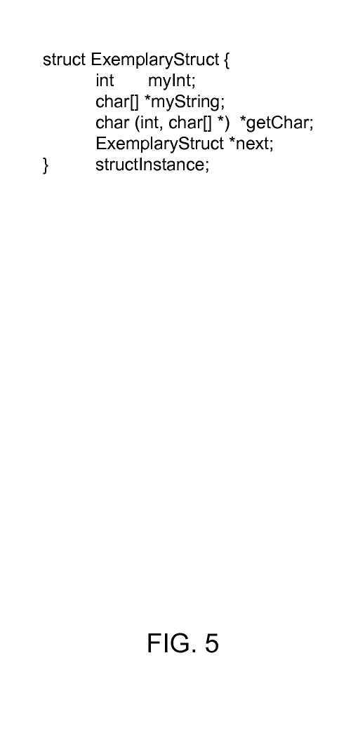

FIG. 5 illustrates an exemplary data structure called “ExemplaryStruct” represented in “C” code that may be implemented within execution environment 102 using SDSS 104. Within the data structure of FIG. 5 are variable definitions. These variable definitions include an integer variable called “myInt”, a character array pointer called “myString”, a function pointer called “getChar”, and a structure pointer called “next” that may be used to point to another structure of type “ExemplaryStruct.”

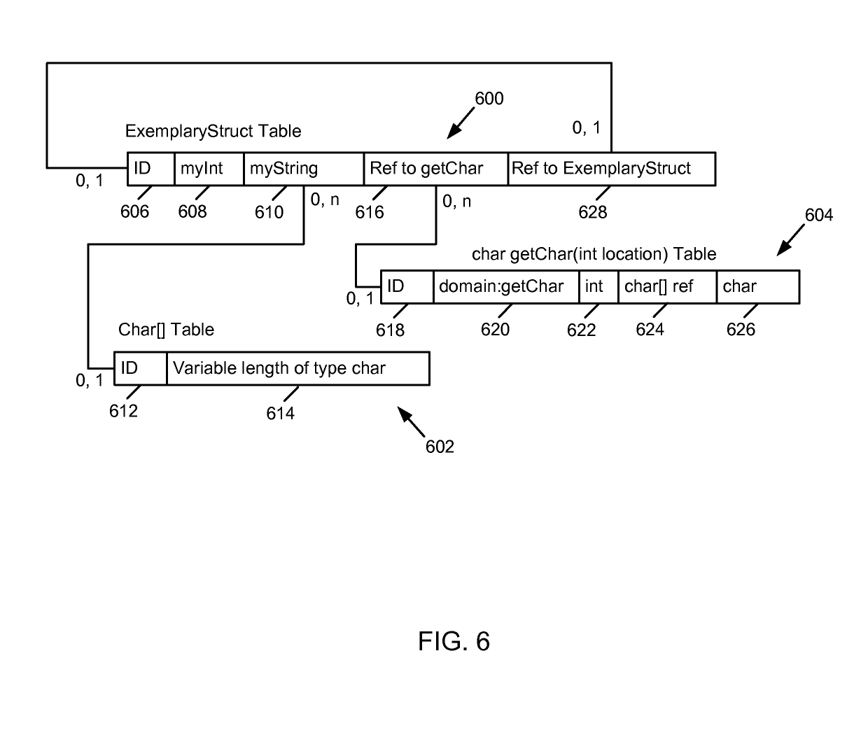

FIG. 6 illustrates exemplary SDSS table entries that may be used to support instances of the data structure of FIG. 5 within SDSS 104. An “ExemplaryStruct” table 600 provides storage in columns for portions of the “ExemplaryStruct” addressable entity in each record. The order and type of the columns in the table support the data organization of the structure for an instance of the “ExemplaryStruct” structure. A “char[ ]” table 602 may be used to store a variable length character array. A “getChar(int, char[ ] *)” table 604 may be used to store code block instance records for code blocks with a matching invocation signature, and corresponds to the “getChar” function pointer of the structure referenced by FIG. 5.

Within “ExemplaryStruct” table 600, an identifier column 606 in a record of the table may store an SDSS identifier that may be used to reference a record of “ExemplaryStruct” table 600, which corresponds to an ExemplaryStruct addressable entity. A “myInt” column 608 may be used in a record of the table to store a value for integer variable “myInt” addressable entity depicted within an exemplary structure of FIG. 5. A “myString” column 610 in a record of the table may be used to store an SDSS identifier serving as a pointer to a record in a char[ ] type table 602 corresponding to “myString” addressable entity within the structure of FIG. 5. The value stored within “myString” column 610 may be a value also represented in an identifier column 612 in a record of “Char[ ]” table 602. A variable length “char” column 614 may be used within a “Char[ ]” table 602 record to store a variable length character string up to the bounds of the allocated storage.

A “getChar” column 616 in a record of the “ExemplaryStruct” table 600 may be used to store an SDSS identifier to serve as a pointer to a code block instance record referenced by the “getChar” pointer within the structure of FIG. 5. The value stored within “getChar” column 616 may be a value represented by a identifier column 618 in a record of “getChar(int, char[ ] *)” code block instance table 604.

A symbol table 402 record may be associated with the “getChar(int, char[ ] *) code block instance table. The symbol table may provide a reference to the code block table record for the “getChar(int, char{ } *)” code block. A name column 620 is used to stored the name of the instance. Name may be namespace qualified as indicated by the “domain:” prefix in the value in column 620. Column 620 is optional and not required for the operation of the system and method. An “int” column 622 may be used in a record as a location for storage of an integer parameter value for a value passed to an invocation of the addressable code block entity associated with “getChar(int, char[ ] *)” code block instance table 604 record. A “char[ ] ref” column 624 in a record may be used as a location for storage of a character pointer parameter value for a value passed to an invocation of the addressable code block entity associated with “getChar(int, char[ ] *)” code block instance table 604 record. The character pointer value may be another SDSS identifier that references another character table record. A “char” column 626 in a record of the “getChar(int, char[ ] *)” code block instance table 604 may be used to store a return character value to be generated upon an invocation of the addressable code block entity associated with “getChar(int, char[ ]*)” table 604.

An “ExemplaryStruct” column 628 in a record of “ExemplaryStruct” table 600 may be used to store an SDSS identifier, which may be used to locate the addressable entity, which is an instance of the structure of FIG. 5 stored in a record of ExemplaryStruct Table 600.

It should be noted that addressable entity data elements within an instance of the structure may be stored by value in the structure instance's root table record or they may be stored by reference in the root table record to a record in a type table associated with the element. The exemplary structure instance shows both techniques. Nested structures may be included by reference or by value as well. The exemplary structure instance further includes a pointer to a function, which is represented by a reference to a record in a matching code block instance table. The exemplary structure instance also has a pointer to another structure of the same type. This may be represented as a reference to a record in the structure's type table.

As described above, object oriented languages are translated to machine code for processing. Accordingly, a system that supports functional programming languages may also support object-oriented language generated programs. Classes may be thought of as structured types and may be handled as the structures described in association with FIGS. 5 and 6 above.

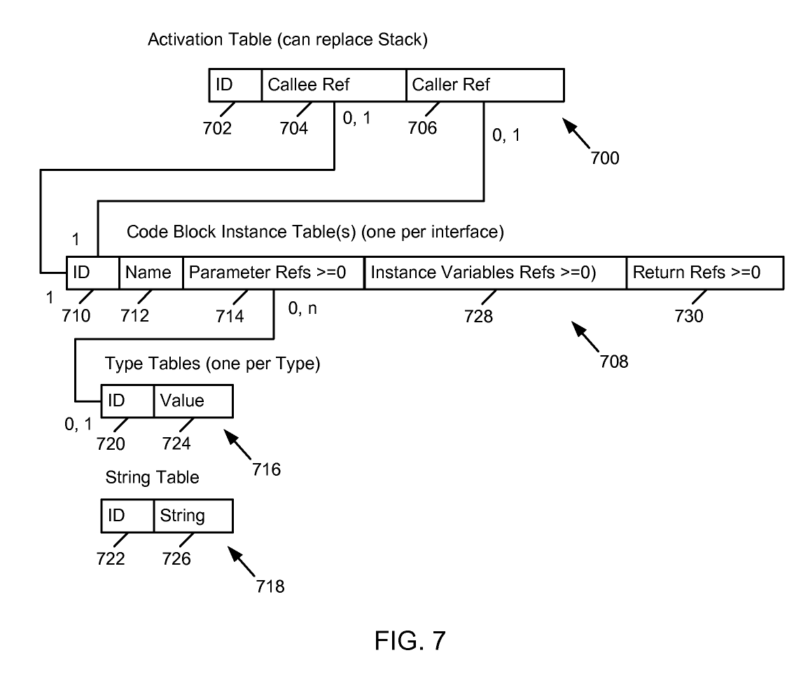

FIG. 7 illustrates exemplary SDSS tables that may be involved in an embodiment of function/subroutine (code block) activation within execution environment 102. As described above, when a function or subroutine invocation, an anonymous or private code block, or a jump/goto command is encountered in an addressable machine code entity, execution environment 102 may create an activation record containing an identifier/reference of the callee code block instance and the called code block instance. A code block instance record may be created for the called code block instance prior to the call or jump being executed. Code block instance tables may have records that match the signature of the code block they represent based on information provided in an object file. Accordingly, the called code block instance record may include zero or more columns for parameter passing, zero or more columns for instance variables, and zero or more columns for returning results.

The embodiment shown in FIG. 7 illustrates an embodiment where all the data in the instance record is an identifier of a record in other tables. That is, each column, except the “identifier” column, contains a reference to an addressable entity. Accordingly, FIG. 7 illustrates a technique for “pass-by-reference” parameter passing. “Pass-by-value” parameter passing may be implemented by passing the value in the code block instance table record or by passing a reference to a record in type table created specifically for the called instance and not accessible by the callee instance. Pass-by-reference parameters may be supported by using references in the instance record to type table records that are accessible to both the callee and the caller.

An activation table 700 combined with code block instance tables 406, as described above, may be used to replace the stack of a conventional execution environment. An activation table 700 record may be referenced by an SDSS identifier within identifier column 702 and may be referenced within SDSS 104 by use of this SDSS identifier. A “Callee Ref” column 704 may be used to store an SDSS identifier for a called code block instance record in an activation table 700 record. A “Caller Ref” column 706 may be used to store an SDSS identifier for a calling code block instance record block instance record in an activation table 700 record. Both the caller and callee code block instance records may be referenced by use of the respective SDSS identifiers within SDSS identifier space 122. Accordingly, activation table 700 along with code block instance tables may be used to replace a stack by storing SDSS identifiers for called and calling code blocks within execution environment 102 providing access to, for example, parameter data, instance data, and return results data.

A code block instance table 708 may exist for each of the caller and callee code blocks. An identifier column 710 may store an SDSS identifier that may be used to identify code block instance table 708 record within SDSS 104. As described above, an SDSS identifier stored within identifier column 710 may be used to reference code block instance table 708 record by storing the SDSS identifier within “Callee Ref” column 704 of activation table 700 record. A name column 712 may be used to store a name, for example, used as an identifier for the callee code block record.

As described above, zero or more parameters may be used by a code block during processing. One or more columns as indicated by “Parameter Refs>=0” 714 may be used to reference zero or more parameters. Parameters may be referenced, as with other addressable entities within execution environment 102, by use of an SDSS identifier for each parameter. A parameter reference column may contain a reference to a type table record where the type matches the type required for the parameter. Type table 716 in FIG. 7 represents a format (identifier, value) for a record that is acceptable for simple types, and string table 718 is a specific example of a string type table (identifier, string). An identifier column 720 and an identifier column 722 may be used to store SDSS identifiers that may be used in columns within “Parameter Refs>=0” 714 to reference a record in a type table 716 and a record in a string type table 718. A value column 724 and a string column 726 may store a value matching the type of the type table, as a string is stored in the corresponding “value” column of the string type table, respectively, as parameter values for a code block instance table 708 record.

As described above, zero or more variables may be used by a code block. “Instance Variables Refs>=0” 728 represents zero of more columns which may be used to reference zero or more instance variables. As with parameters, instance variables may also be stored in type tables, which may be referenced by SDSS identifiers (not illustrated in FIG. 7). As also described above, zero or more return values may be returned to a calling code block by a called code block. “Return Refs>=0” 730 represents zero or more columns which may be used to reference zero or more return values. As with parameters and instance variables, return values may also be stored in records of type tables, which may be referenced by SDSS identifiers (also not illustrated in FIG. 7). By use of type tables for return values and by allowing multiple return values, multiple types of return values may be returned to a calling code block from a called code block.

After the instance record is created, the callee may be provided access to it either directly via a register pointing to it setup by machine code generated from the associated source or indirectly via an interrupt or SDSS library routine which on return makes the instance record accessible typically through a register. The register may contain the SDSS identifier for the instance record or a processor memory address corresponding to the location of the instance record in processor memory. The callee's object code may read and may write to parameters in the record if allowed by access control of SDSS 104, if there are any parameters. Similarly, the caller's object code may access the record to access any returned results.

SDSS manager 108 may initialize instance variables either prior to parameter initialization or after parameter initialization. The instance record may be made available to the callee's machine code and control may be passed to the first instruction. If the called code is not a jump command and it returns results, it may use the column(s) provided in the instance record. The return may be handled by execution environment 102, which may return control to the caller. The exact point of return in the caller may be stored by the execution environment using its own storage, or may store the information in an activation record or a code block instance record as already described. Access to the instance record of the caller is restored, if necessary, allowing the instructions in the caller addressable code block entity to continue processing using it's own parameters and instance data, for example.

Numerous other table and record structures are possible for supporting execution environment 102. Other SDSS types other than an SQL SDSS may be used to implement the subject matter described herein. Accordingly, all SDSS types capable of supporting SDSS identifier references to storage locations and entities associated with the storage locations may be used and all are considered within the scope of the subject matter described herein. The discussion of FIG. 7 above describes passing data between caller and callee using references in code block instance records. As noted previously, some or all of the data may be passed by storing data values in the instance records. Both methods may support pass-by-value, where only the code block receiving the value may access the data after a change in control between code blocks, and both may support pass-by-reference, where the code block giving up execution control retains access to the data storage location(s) passed to the callee.

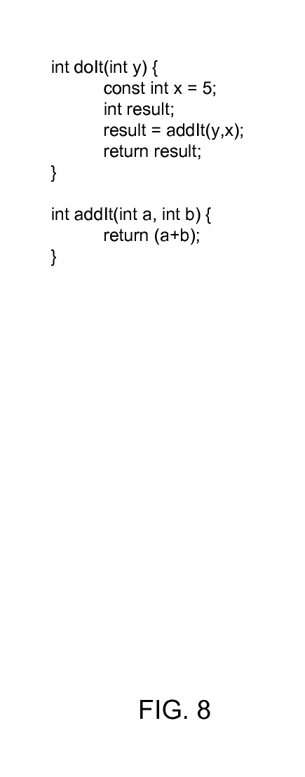

FIG. 8 illustrates exemplary “C” code for two source code routines from which a plurality of addressable object entities may be generated that may be processed within execution environment 102 and stored within SDSS 104. The first routine called doIt( ) calls the second code block called addIt( ) within the doIt( ) routine. An integer parameter “y” is received when the doIt( ) routine is called from within a program. Within the doIt( ) routine, a constant integer “x” is defined to have a value of 5. An integer variable called “result” is defined and the variable “result” is assigned a return value from an invocation of the addIt( ) routine. When the addIt( ) routine is called by the doIt( ) routine, the addIt( ) routine is passed the received parameter “y” and the constant integer value of “x.” The addIt( ) routine receives integer parameters “a” and “b.” The integer parameters “a” and “b” are added and the sum is returned by the addIt( ) routine. As described above, the value returned from the addIt( ) routine is assigned to the “result” variable within the doIt( ) routine. Finally, the “result” value is returned by the doIt( ) routine to the calling program.

As can be seen from FIG. 8, the doIt( ) routine takes one integer parameter as a pass-by-value input and returns the integer result. When the doIt( ) routine calls the addIt( ) routine, the doIt( ) input parameter “y” and the constant integer “x” are pass-by-value input parameters provided to the addIt( ) routine. The addIt( ) routine adds the two input parameters and returns the sum. The doIt( ) routine returns the results of the addIt( ) routine.

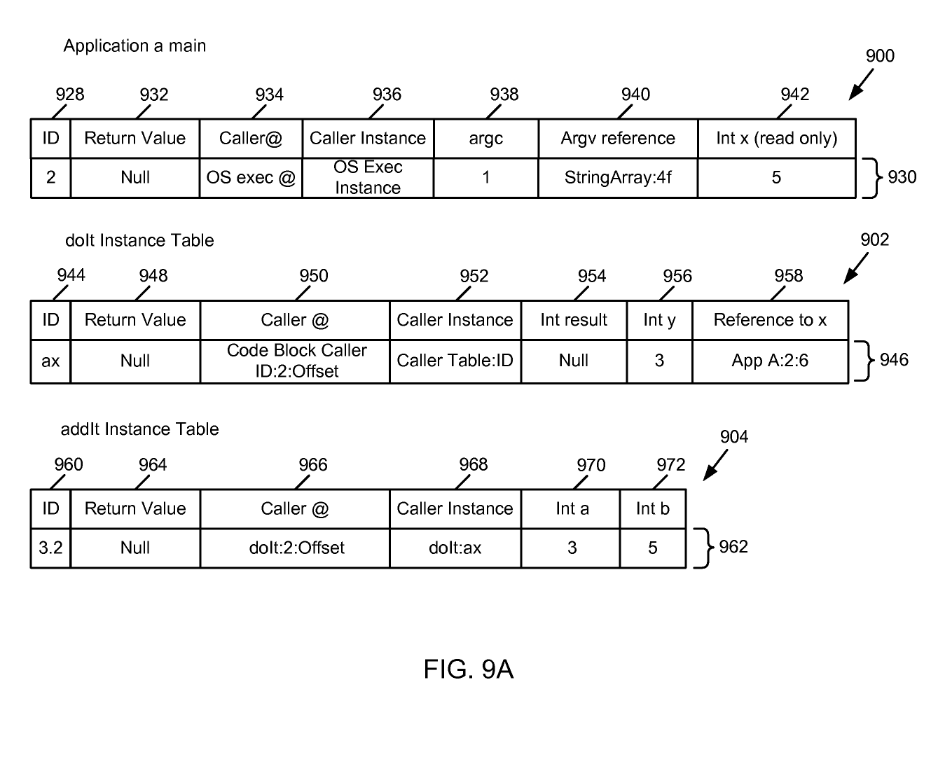

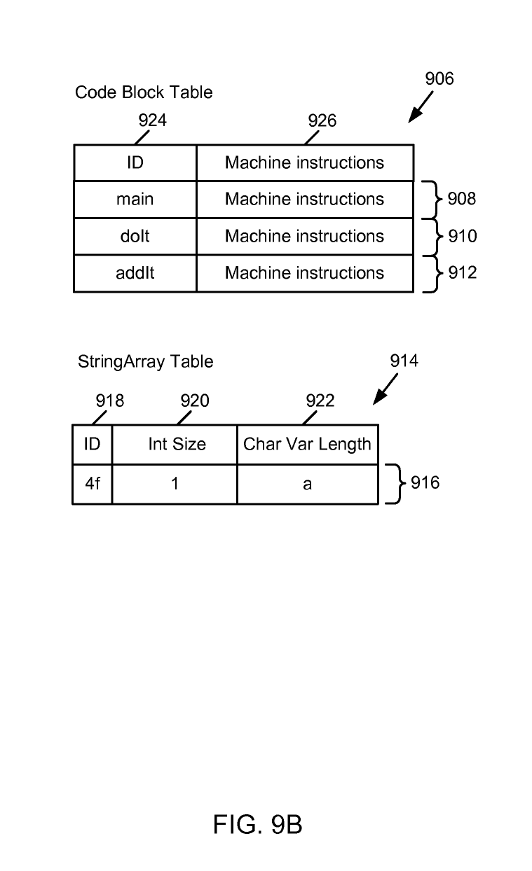

FIGS. 9A and 9B illustrate exemplary SDSS tables that may be used to represent the “C” code illustrated in FIG. 8. In the example to be described, an instance of an application named “a” has been created. The application instance “a” has a “main( )” routine, as programs written in “C” are known to have. The application “a” may have a number of other functions, subroutines, and code blocks. At some point in the processing of application “a” an instance of doIt( ) is created and invoked. The processing of doIt( ), as can be seen from FIG. 8, results in the creation and invocation of an instance of addIt( ). FIGS. 9A and 9B illustrate both code block instance table definitions and populated values for columns within code block instance table records associated with the “C” code illustrated in FIG. 8 associated with this example. The values represented within FIGS. 9A and 9B represent a point in time just after an instance of the addIt( ) routine has been invoked by an instance of the doIt( ) routine. The instance of doIt( ) has been invoked by an unspecified portion of code in application “a”.

The machine instructions for both routines in execution environment 102 may be stored in records in a code block table as described earlier along with records of other code blocks including the main( ) routine whose invocation eventually resulted in the invocation of a doIt( ) instance as in this example. It should be noted that the actual storage layout within SDSS 104 may be either sequential or non-sequential for the respective addressable object entities. Accordingly, the instructions do not need to be in a common code segment in order to function within execution environment 102. A loader may be implemented to optimize storage within SDSS 104 by placing the two records in a common processor memory region without departing from the scope of the subject matter described herein.

As will be described in more detail below, each routine may have a code block instance table associated with it. In FIG. 9A, there is only one instance of each code block represented. However, more code block instances may be represented using the subject matter described herein. It should be noted that code block instance tables may be viewed as replacements for conventional stack frames in this example. The embodiment depicted in FIG. 9A does not require the use of an activation table as was described in an earlier alternate embodiment. The return address of the calling instance is stored in the code block instance using two columns in the depicted embodiment. A record column labeled “Caller Instance” 952, for example, which identifies the caller's code block instance table and record identifier may contain an SDSS identifier that identifies the instance and a machine code column in a code block record of the caller instance. A column labeled “Caller @” 950, for example, contains the return offset into machine code column of the code block table record where the associated “Caller Instance” code is stored. Constants may be referenced in code block instance records, or referenced by value or address in the machine code of a code block table record where an address is an SDSS identifier or an address corresponding to the storage associated with the SDSS identifier. However, for ease of illustration, constant data within FIG. 9A is illustrated within the respective code block instance tables.

In FIG. 9A, application “a's” main( ) code block instance table 900, doIt( ) code block instance table 902, and addIt( ) code block instance table 904 are illustrated. In FIG. 9B, a code block table 906 containing or referencing the machine code of each code block in application “a” may be used within SDSS 104 to associate SDSS identifiers with code blocks within execution environment 102. Accordingly, as can been seen from FIG. 9B, code block table 906 includes a record 908 enabling access to machine code for the main( ) routine, a record 910 enabling access to machine code for the doIt( ) routine, and a record 912 enabling access to machine code for the addIt( ) routine. Accordingly, execution environment 102 may have access to machine code blocks that are referenced by SDSS identifiers associated with each code block. The identifiers depicted are for illustration only and may not be suitable in some working execution environments because they might not distinctly identify each code block record in embodiments where one code block table may be shared by programs.

A string array table 914 may be used to reference string arrays within execution environment 102. In the examples being described, the String array table 914 includes a record 916 to store the name of the program, “a”, which is passed as a parameter to the main( ) routine in the argv array familiar to “C” programmers. In this example, parameters are provided when application “a” is invoked, so the well-known “C” variable argc has a value of 1, as depicted in the argc column 938 of the record 930 shown. The well-known array argv is stored as a reference in the argv column 940 to the StringArray type table record 4f. Accordingly, string array table 914 includes an identifier column 918 with an identifier value in record 916 of “4f”. String array table 914 includes a “size” column 920 of type integer that contains a value of 1 in record 916 indicating the length of array in “char Var Length” column 922 of record 916 with identifier “4f”. String array table 914 includes “char Var Length” column 922 that includes a value for the name of the program “a” associated with the main, doIt, and addIt routines being discussed.

When a program begins execution, machine instructions may be accessed for the first-referenced code block. Accordingly, execution environment 102 may search code block table 906 for an identifier associated with an initial code block of the program. Within code block 906 an identifier column 924 is shown to include an identifier for the main( ) routine. Code block 906 also includes a machine code instructions column 926 and machine code instructions within record 908 for the main( ) routine. Record 910 of code block table 906 includes an identifier within identifier column 924 for the doIt( ) routine. Machine code instructions for the doIt( ) routine may be stored in machine code instructions column 926 of record 910. Record 912 of code block table 906 includes an SDSS identifier for the addIt( ) routine in identifier column 924. Machine code instructions for the addIt( ) routine may be stored in machine code instructions column 926 of record 912. Machine code instructions that execute outside the execution environment 102 in a conventional execution environment supported by processor memory 120 under control of a conventional MMS may be located via a reference in column 926 of code block table 924.

Code block instance table 900 includes an SDSS identifier column 928 with a value of “2” in record 930 of code block table 900 for the instance of main( ) associated with the instance of application “a” in the example being described. Accordingly, the instance of the main( ) routine may be referenced through its code block instance table and record identifier. A return value column 932 within code main( ) block instance table 900 is shown to have a null value within record 930, since application “a” is currently executing and thus has not yet returned a result. A “Caller @” column 934 within code block table 900 is shown to have a value of “OS exec @” within record 930, which here is simply an indicator that the caller is an operating system executable. The address of the caller instruction to return to is stored in the location where “OS exec @” appears in FIG. 9A. A “Caller Instance” column 936 is shown to have a value of “OS exec instance” within record 930 of code block 900, which represents the address of the stack frame or code block instance record of the caller.

Note that the address for both “Caller Instance” and “Caller @” may include conventional execution environment processor addresses or SDSS identifiers. These two columns are illustrative and indicate that the instance of main( ) was called by an instance of an operating system function, exec( ), whose purpose is to launch applications. When application “a” ends, control will be return to the exec( ) instance identified in the “caller instance” column at the address indicated in the “caller @” column. An “argc” column 938 is shown to include a value of 1 in record 930 of code block table 900 as discussed earlier. An “argv reference” column 940 is shown to have a value of “string array: 4f” in record 930 of code block table 900. As described above, string array table 914 included the value of “4f” within identifier column 918 of record 916. An “x” “column 942 is shown of type integer which has an attribute of “read-only” stored in its associated symbol table 402 record (not shown). The value of 5 is shown in “x” column 942 in record 930 of code block table 900. In this example the code block instance table for application “a” contains columns for certain global and static data and constants for the application. As described above, constant data, global data, and static data may be alternatively stored in separate data type tables and/or in other code block instance tables without the departure of the scope of the subject matter described herein.

As described above with regard to FIG. 8, the doIt( ) routine is invoked and executed as a result of the invocation of the main( ) routine. Accordingly, when machine code instructions for the doIt( ) routine are to be accessed, code block table 906 may be accessed at record 910 using SDSS identifier “doIt” and doIt instance table record ‘ax’ 946 may be created in doIt instance table 902 within SDSS 104. An SDSS identifier column 944 is shown to include a value of “ax” in record 946 of instance table 902 illustrating that SDSS identifiers may be non-numeric. The doIt instance table identifier and record identifier ‘ax’ serve as the SDSS identifier or address of the data record associated with this instance of doIt( ). A return value column 948 is shown to have a value of null in record 946 of instance table 902.

As described above, the state of execution environment 102 as depicted in FIGS. 9A and 9B is immediately after the invocation of the addIt( ) routine. Accordingly, no value has been placed within return value column 948 of record 946 in instance table 902. A “Caller @” column 850 is shown to include a value of “Code Block Caller identifier:2:Offset” in record 946. A “Caller Instance” column 952 is shown to include a value of “Caller Code Block Instance Table: identifier” in record 946 of instance table 902. The values in these two columns are illustrative of the caller instance of this doIt( ) instance which is unspecified in this example and the offset into the caller's code block where execution control is to be returned when doIt( ) returns. A “Result” column 954 of type integer is shown to include a null value in record 946 of instance table 902.

As described above, an instance variable, “result”, for the doIt( ) routine has not yet been assigned a value since the invoked addIt( ) instance has not yet returned. A “y” column 956 of type integer is shown to include a value of “3” in record 946 of instance table 902. This value of “3” may be assumed to have been passed into the doIt( ) routine as the parameter y described in association with FIG. 8 above. A “reference to x” column 958 is shown to include the value of “App:A:2:6” in record 946 of instance table 902. Accordingly, the value within “reference to x” column 958 of record 946 refers back to application main( )'s code block instance record with an SDSS identifier of “2”, as described above, stored in identifier column 928 of record 930 within code block table 900, and the value of “6” represents the column within code block table 900 at record 930 to “Int x (read only)” column 942 which includes a value of “5” in record 930. In this way, constant data may be referenced within SDSS execution environment 102 by use of SDSS identifiers and SDSS identifier offsets.

The addIt( ) instance table 904 includes an identifier column 960 with a value of “3.2” in record 962. A return value column 964 includes a null value in record 962. As described above, the state of execution environment 102 as illustrated in FIGS. 9A and 9B is immediately after the addIt( ) routine has been invoked. Accordingly, no return value has been assigned yet. A “Caller @” column 966 includes a value of “doIt:2:offset” in record 962. As described earlier this is a reference into code block table 906 to a record with identifier “doIt”, column 2, the machine code column, and finally the offset into the machine code of the record 910. A “Caller Instance” in column 968 includes a value of “doIt:ax” in record 962. This value of “ax” correlates to the SDSS identifier in identifier column 944 of record 946 in doIt instance table 902 and represents an SDSS identifier reference to the calling instance of doIt( ). An “Int a” column 970 includes a value of “3” in record 962 of instance table 904. An “Int b” column 972 includes a value of “5” in record 962 of doIt instance table 904. These two values correlate to the parameters “a” and “b” passed into the addIt( ) routine as described above in association with FIG. 8. As previously described, these parameters were passed by value. Accordingly, the values of “3” and “5” are illustrated in “Int a” column 970 and “Int b” column 972 in record 962 of instance table 904.

However, as described above, pass-by-reference parameter passing is also possible. In such a situation, SDSS identifiers may alternatively be passed instead of values. When pass-by-reference parameters are used, an SDSS identifier, such as the SDSS identifier value within “reference to x” column 958 of record 946 in instance table 902 could be used to pass a value to a subroutine without departure from the scope of the subject matter described herein. The machine code generated by the compiler is adapted to the parameter passing mechanism and the formats of the storage locations just described.

### Compilers, Linkers, and Loaders in an SDSS Environment

Tools to allow programs to be executed within an execution environment 102 include compilers, linkers, loaders, interpreters, system libraries, and programming languages themselves. Accordingly, all are considered within the scope of the subject matter described herein.

In the following description, the functions of compiling, linking, and loading object models for use in execution environment 102 are described in association with respective SDSS-compatible components, such as compiler 106, compiler/interpreter 126, and loader/linker 128. This description is merely illustrative and other configurations are contemplated to be within the scope of the subject matter described here. For example, the compiling, linking, and loading functions can be distributed or apportioned among the compiler 106, compiler/interpreter 126, and loader/linker 128 components. Moreover, some or all of the compiling, linking, and loading functions can incorporated into the functionality of SDSS 104, particularly into the functionality of SDSS manager 108, such as the functions performed by compiler/interpreter 126, and loader/linker 128.

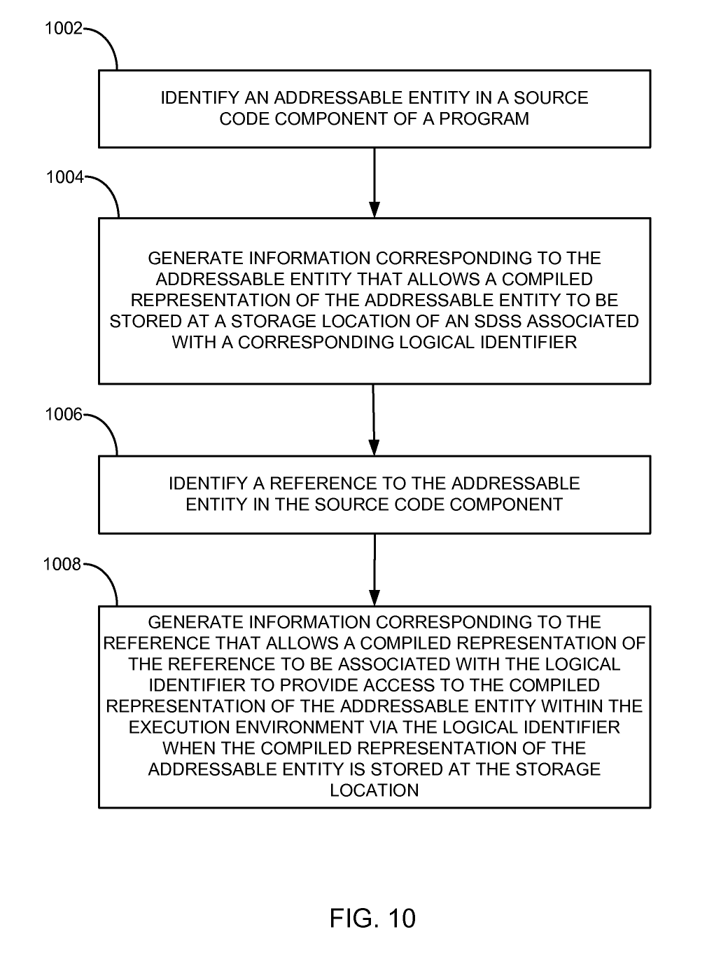

Returning to FIG. 1, compiler 106, compiler/interpreter 126, and loader/linker 128 may perform execution environment 102 compatible compiling, linking, and loading functions. GUI 110 may be used to invoke compiler 106, compiler/interpreter 126, and loader/linker 128 to compile, link, and/or load programs into the execution environment 102. GUI 110 may also allow users to execute programs within execution environment 102. FIG. 10 illustrates an exemplary process for compiling program source code components, such as source code 116, that may be implemented by the compiler function of compiler 106 and/or compiler/interpreter 126 illustrated in FIG. 1. Referring to FIG. 10, at block 1002, the process identifies an addressable entity in a source code component of a program. For example, compiler 106 and/or compiler/interpreter 126 identify an addressable entity in a source code component of program source code 116.

At block 1004, the process generates information corresponding to the addressable source code entity that allows a compiled representation of the addressable entity to be stored at a storage location of SDSS 104 associated with a corresponding SDSS identifier as at least a portion of a compiled program derived from the source code 116. As described above, SDSS execution environment 102 provides at least part of an execution environment for the program. For example, compiler 106, compiler/interpreter 126, and/or execution environment 102 may generate an SDSS identifier for storage within an identifier column 606 in a record of ExemplaryStruct table 600, as illustrated in FIG. 6, to allow the corresponding compiled representation of the addressable entity to be stored and located at a storage location of SDSS 104 associated with the SDSS identifier stored in identifier column 606.

At block 1006, the process identifies a reference to the addressable entity in the source code component. For example, when other instructions within program source 116, reference an instance of ExemplaryStruct depicted in FIG. 5, compiler 106 and/or compiler/interpreter 126 may detect this reference. The reference to the addressable entity identified by the complier may be identified in any of a variable, a constant, or an instruction of the source code.

At block 1008, the process generates information corresponding to the reference that allows a compiled representation of the source reference to be associated with the SDSS identifier to provide access to the compiled representation of the addressable entity within the execution environment when the addressable entity is stored at the storage location of SDSS 104. For example, compiler 106 and/or compiler/interpreter 126 may create a reference to the SDSS identifier stored within a record in identifier column 606 associated with ExemplaryStruct table 600 illustrated in FIG. 6 so that the source instruction executing on processor 118 that references an instance of the structure may access the record in ExemplaryStruct table 600 within execution environment 102 via the SDSS identifier.

The generated information corresponding to the compiled representations of the addressable entity and the reference may include a symbol allowing loader/linker 128 to resolve the compiled representation of the reference to a storage location using the SDSS identifier. When the reference to the addressable entity detected in the source code is an instruction of the source code, compiler 106 and/or compiler/interpreter 126 may generate an object code instruction corresponding to the source code instruction. The object code instruction may include the compiled representation of the reference as an operand to provide access to the addressable entity during execution of the object code instruction within the execution environment after the compiled representation of the reference is resolved to a storage location by loader/linker 128 using the SDSS identifier.

As stated above, an addressable entity that is stored within SDSS 104 and generated by compiler 106 and/or compiler/interpreter 126 may include any suitable entity from a program, including a data variable, a data constant, and a code block. A code block may include a subroutine, a function, a method, or a labeled instruction. In addition, the addressable entity may be referenced as a target of a call and/or a branch operation in the source code component, a data access corresponding to a source code instruction, and/or a reference in an addressable data entity, for example.

According to another aspect of the subject matter described herein, the information generated by compiler 106 and/or compiler/interpreter 106 during the compiling process may be stored in at least one file or library together with information, enabling a loader to invoke SDSS commands resulting in the loading of at least a portion of the file or library into SDSS 104 in the execution environment 102. In one exemplary implementation, the information may include structured query language (SQL) commands.

According to another aspect of the subject matter described herein, an addressable set of source instructions included in a source code component of source code being compiled by compiler 106 and/or compiler/interpreter 126 may be represented as machine code instructions in a code block storage component of the SDSS 104 and instance data for the machine code instructions may be represented in a code block instance storage component associated with the code block storage component in SDSS 104.

For example, an instance of a source code function may be represented after compiling by one or more machine code instructions stored in a code block storage component invoked by processor 118 in association with a code block instance storage component location accessible to the machine code instructions during processing of the instance. The instance data in the code block instance storage may include storage for input parameters, output parameters, return values, references to constants, references to static and global variables, and references to invoking instructions associated with the code block instance. The machine code instructions may provide access to a data item in the code block instance storage to allow the machine code instructions to use the data during processing. The machine code instructions generated during compilation can also include instructions for invoking an SDSS routine configured to use SDSS commands to create the instance in the code block instance storage component in conformance with the schema.

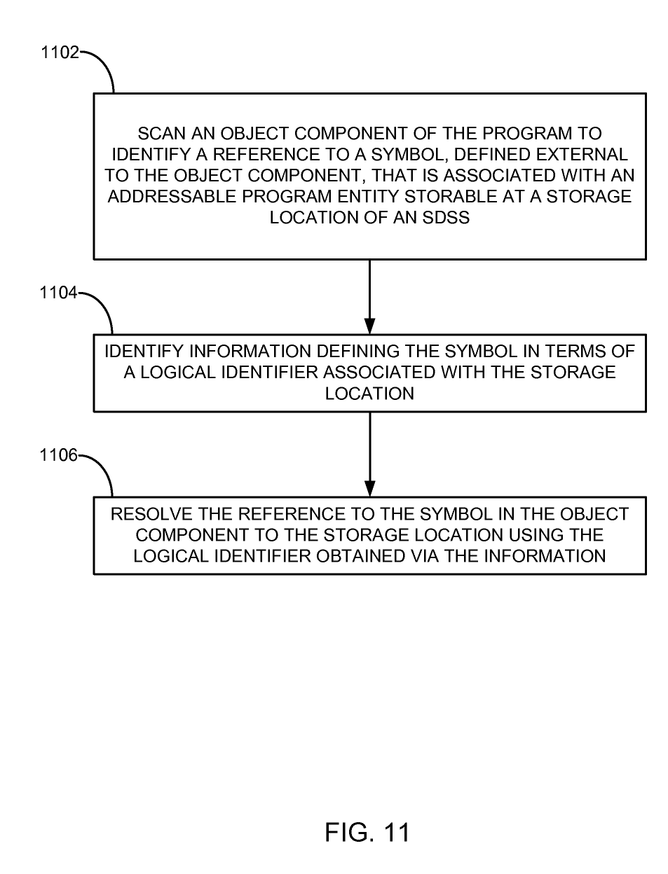

FIG. 11 illustrates an exemplary process for linking addressable object entities that may be performed by the linker component of loader/linker 128. Referring to FIG. 11, at block 1102, the process may scan an object component of a program to identify a reference to a symbol defined external to the object component. The symbol can be associated with an addressable entity storable at a storage location of SDSS 104 associated with a corresponding SDSS identifier. SDSS 104 provides at least part of the execution environment for the program. For example, the linker function of loader/linker 128 may scan an object file to identify a reference to a symbol in the object file that requires resolving using SDSS 104. The linking may be performed on the object component contained in a file and/or a library prior to loading, or the linking may be performed on the object component during or after loading into an execution environment.

At block 1104, the process may identify information defining the symbol in terms of the SDSS identifier associated with the storage location of the addressable entity. For example, the linker function of loader/linker 128 may access a symbol table associated with an addressable entity stored in an object file or loaded into an execution environment to locate a symbol matching the referenced symbol.

At block 1106, the process may resolve the reference to the symbol in the object component to a storage location associated with an addressable entity using an SDSS identifier obtained via the information in the symbol's corresponding record in the symbol table.

Persons skilled in the art of linkers will understand that resolving a reference typically does not require a full symbol or SDSS identifier. For a static entity in an external program, a full identifier may be required. For a static entity in the same program, only the table and record identifier may be required to enable resolution. For resolving dynamic references which include references to instances of addressable entities not yet created, both a table and record identifier may be required, but in some cases only a record identifier is required. The generated machine code can set up registers, which complete links resolved with partial SDSS identifiers. This is analogous to traditional linkers performing “fixups” by providing only an offset, relying on the generated machine code to setup a pre-specified register with a base address prior to access to the instance occurring. This discussion is consistent with the definition of an SDSS identifier provided earlier, which defines an SDSS identifier as a portion of a full SDSS identifier required in a given context to locate the associated storage location.

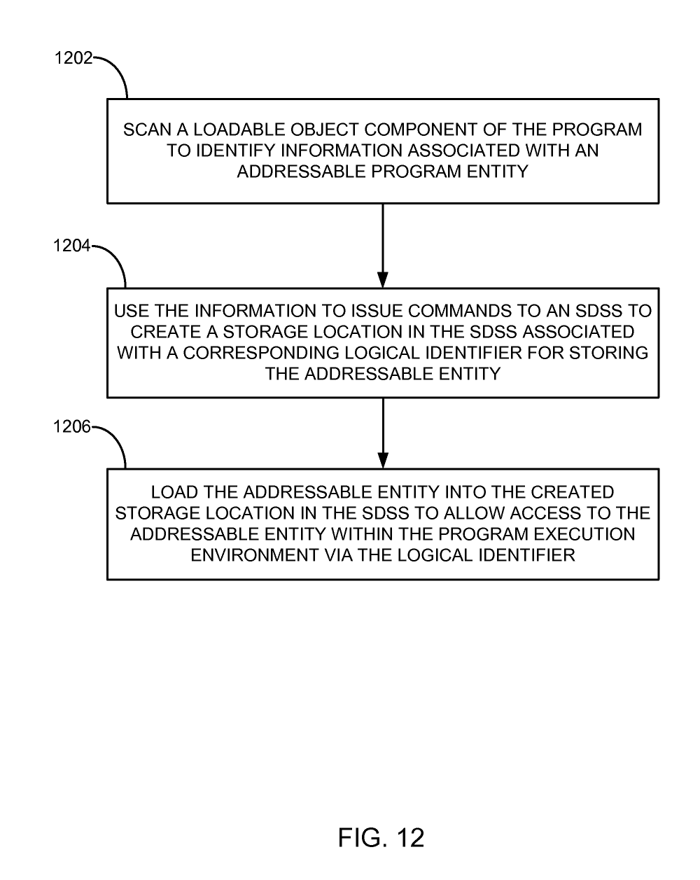

FIG. 12 illustrates an exemplary process for loading at least a portion of an object code component into an execution environment 102. The steps illustrated in FIG. 12 may be performed by the loader component of loader/linker 128 illustrated in FIG. 1. Referring to FIG. 12, at block 1202, the process may scan a loadable object component generated from one or more source code components, e.g., via compiler 106 and/or compiler/interpreter 126, to identify information associated with an addressable entity. For example, the loader component of loader/linker 128 may scan an object file to identify information associated with addressable entities in the object file. As an example, loader/linker 128 loading an object file that makes use of an ExemplaryStruct addressable entity illustrated in FIG. 5 would identify information associated with the ExemplaryStruct addressable entity.

At block 1204, the loading process may use the information to issue commands to SDSS manager 108 to request a storage location in SDSS 104 associated with a corresponding SDSS identifier for the addressable entity. SDSS 104 provides at least part of an execution environment for the program, as described above. For example, the loader component of loader/linker 128 may use the information to issue commands to SDSS manager 108 to request a storage location in SDSS 104 storage for ExemplaryStruct table 600 and records in ExemplaryStruct table 600 for ExemplaryStruct addressable entities as required. More specifically, the information may enable the loader function of loader linker 128 to instruct SDSS manager 108 to create ExemplaryStruct table 600 illustrated in FIG. 6. If the object file contains a static or global instance of ExemplaryStruct, for example, the loader may encounter information enabling it to request the creation a record in table 600 for storing the static or global addressable entity. Information may be contained in the object file that enables the loader to instruct SDSS manager 108 to initialize the addressable entity. If the loader identifies information that dynamic instances of ExemplaryStruct may be needed, the loader may add information to a symbol table record associated with ExemplaryStruct, enabling records to be added and removed for ExemplaryStruct instances as needed for additional ExemplaryStruct addressable entities.

The loader may also provide information to an ExemplaryStruct symbol table record to enable a run-time linker to resolve any unresolved references to ExemplaryStruct addressable entities allowing ExemplaryStruct instances to be located during processing. For global or static addressable entities, a complete SDSS name/URI, table and identifier, or just an identifier may be provided. For dynamic addressable entities, an identifier for the table may be provided allowing the generated machine code to allocate a dynamic instance and generate the remainder of the identifier as an offset or column identifier in the object code.

At block 1206, the loading process may load the addressable entity into the created storage location in SDSS 104 storage to provide access to the addressable entity within the program execution environment 102 via the SDSS identifier. If static or global instance initialization is identified, the loader may instruct SDSS manager 108 to create records in the table for the addressable entities and initialize the records associated with the addressable entities created in step 1204.

As described above, the functions corresponding to the subject matter depicted in FIG. 12 can be performed by SDSS 104. Thus, SDSS 104 can operate to perform the loader function of loader/linker 128. For example, the loading process used to issue commands to SDSS manager 108 of SDSS 104 to request a storage location in SDSS 104 associated with a corresponding SDSS identifier data store for the addressable entity can be included in SDSS manager 108 itself or another component of SDSS 104 not shown in FIG. 1. Moreover, the process used to load the addressable entity into the created storage location in SDSS 104 storage to provide access to the addressable entity within the program execution environment 102 via the SDSS identifier can also be included in SDSS manager 108 or another component of SDSS 104 not shown in FIG. 1.

The design of compilers, linkers, and loaders is within the knowledge of persons skilled in the computer and/or software arts, and a detailed discussion of such is beyond the scope of this document. Nevertheless, this document describes in great detail how such tools can be adapted to be compatible with the SDSS environment described here. Many examples and treatises are available for reference in the design of such programming tools. For example, Compilers: Principles, Techniques and Tools, by Alfred V. Aho, Ravi Sethi, and Jeffrey D. Ullman, (ISBN 0201100886), is considered to be the standard authority on compiler basics, and can serve as a primer for the compiling techniques described above. In addition, the reference Linkers and Loaders, by John R. Levine, Morgan-Kauffman, (ISBN 1-55860-496-0), provides background, as the title indicates, on the design and operation of linkers and loaders.

### ILLUSTRATIVE EXAMPLES OF CODE GENERATED BY SDSS-ENVIRONMENT-COMPATIBLE TOOLS

Two examples of pseudo-assembly-code representations follow that illustrate different portions of addressable code block entities that a compiler/linker or interpreter process may generate for processing on a conventional processor as machine code that supports use of execution environment 102 as described in this disclosure. The examples are written in an intermediate form of pseudo assembler. The “_sdss” and “conv” prefixed references represent symbol table IDs that need to be resolved by a compiler or a linker in producing a loadable object file or equivalent, or after loading by a load-time or run-time linker in producing an executable set of machine instructions. Typically, these references would be set to zero in an object file if not resolved by a compiler and the symbol table produced by the complier would indicate the location of each reference and whether it is an SDSS reference or a conventional reference. The symbols are used in the examples for illustrative purposes only.

Both examples perform the same function. The functional steps performed are:
1. Add two numbers stored in a first and a second instance variable.
2. Store the result produced by step 1 in a third instance variable.
3. Call a subroutine passing the result produced in step 1 as input.
4. Compare the value returned from the subroutine to the value of the third instance variable where the value returned is returned in the code block instance record of the called subroutine.
5. If they are equal continue else go to a specified program location.

The pseudo-assembly-code instructions are defined as follows:
L dest, src
Load src into dest. A “[ ]” around an operand indicates using the contents of an enclosed address as the operand. ”[ ]” has a similar meaning for other commands.
ST src,dest
Store src into dest.
ADD op1, op2
Add operands op1 and op2 and return result in register, e.g., AX.
CALL/JMP operand
Call the subroutine or go to the instruction specified by the operand.
PUSH, POP
Stack manipulation instructions well-known to software developers that put and remove data from a stack in processor memory.
CMP op1, op2
Compare the two operands. A comparison flag is “0” if the two operands are equal. The flag is >0, if op1>op2, otherwise the flag is <0.
JNE operand
If the comparison flag value is not zero as the result of a CMP instruction, jump to the location specified by the operand.

The pseudo processor supports general purpose registers AX, BX, and CX, as well as a stack pointer, SP, instruction pointer, IP, extra general purpose registers DX and EX, and a stack frame base pointer register, BP.

Example 1 depicts a pseudo-assembly-code example that performs the function described previously. The code in the example is running in a conventional execution environment in processor memory 120 under control of a conventional MMS accessing addressable data and instruction entities stored in SDSS 104 under the control of the execution environment 102. Note the set of instructions has been invoked via SDSS execution environment 102 as can be seen by its use of a code block instance record for its local data rather than a stack frame. Thus, example 1 illustrates a mixed model depicting code running outside execution environment 102 accessing addressable entities within execution environment 102 enabled by the generation of the object code using development tools including a compiler, a linker, a loader, and/or an interpreter compatible with the mixed execution environment as described.

In an alternate embodiment, the code depicted in example 1 may be run from within an SDSS code block record being monitored by the execution environment 102. In another embodiment, the set of instructions may be compiled to be invoked from a conventional execution environment. In this case, the compiler can generate code that uses the BP register allowing the code to access its local data in its stack frame rather than use DX as a pointer to the code instance's code block instance record.

The processor memory model uses a flat address space, but persons skilled in the art of processor architectures will understand that the code of example 1 may be easily converted to illustrate code using a segmented address space. In example 1, the SDSS storage locations have been memory mapped to a region of memory under control of execution environment 102, which is directly accessible to the instructions of the portion of addressable code block entity shown via processor memory addresses corresponding to SDSS identifiers.

### Example 1

| | |
|---|---|
| 01: ADD | [conv0001],[DX+_sdss0002] |
| 02: ST | AX,[DX+_sdss0003+4] |
| 03: PUSH | _sdss0004 |
| 04: CALL | _sdssGetActivate |
| 05: POP | EX |
| 06: PUSH | EX |
| 07: ST | AX,[EX+paramCol1] |
| 08: CALL | _sdssActivate |
| 09: L | AX,[EX+resultCol] |
| 10: CMP | AX,[DX_sdss0003+4] |
| 11: PUSH | _sdss0005 |
| 12: JNE | _sdssJump |
| 13: ADD | SP,4 |

In example 1, line 01, the contents of two storage locations are retrieved and added by processor 118. The result is placed in the AX register in this example of processor microcode. The first symbol, “conv0001”, represents a storage location in processor memory 102. The second symbol, “_sdss0002”, is a location within SDSS storage pointed to by the DX register, which has already been set. In this example, the DX register points to the code block instance table record for the instance of the set of instructions in the portion of the addressable code block entity being processed. The symbol “_sdss0002” represents a field or column in the record. That is, the symbol represents an addressable data entity. The two symbols are resolved by a linker, either prior to loading or at load-time, and do not need to be re-linked as long as the program, of which they are a part of, remains loaded into SDSS 104. DX is set up in the same manner that EX is setup. Details are provided in the description of line 07 below.

The instruction in line 02 stores the value contained in the AX register, the result of the ADD in line 01, into another column/field of the code block instance table record for the set of instructions. The column/field is represented by the symbol, “_sdss0003”. The “4” may be an offset into the field or an index depending on the arrangement of execution environment 102. For example, the addressable variable entity stored in column “_sdss0003” may be an array, in which case the instruction is replacing the value of the array element having index “4” with the contents of register AX.

Lines 03-09 of the example are instructions generated by a compiler that make a subroutine/function call via execution environment 102. The machine code for the call is associated with the symbol “_sdss0004,” which is associated with a record in a code block table. To locate the processor memory address of the code block table record and get access to the code block instance table record, a compiler may push the SDSS identifier for the code block table record onto the stack. The linker is able to determine the SDSS identifier at load-time, at the latest, and replace the symbol “_sdss0004” with the SDSS identifier in the object code in line 03.

In line 04, an execution environment 102 provided routine, “_sdssGetActivate,” is used by the compiler as an operand to the CALL instruction. This routine, being a system routine, may be linked at load-time or at run-time depending on the implementation of the execution environment 102. The routine “_sdssGetActivate” pops the SDSS identifier off the stack to determine the code block table record and is able to determine the code block instance table associated with the record through a reference in the code block table record in this embodiment. The routine “_sdssGetActivate” uses SDSS commands to allocate a record in the code block instance table for the code block to be called. Initialization may be performed in conformance with the associated schema for the code block instance table. The routine “_sdssGetActivate” pushes the processor address of the instance record onto the stack and returns. The processor address of the instance record for the subroutine associated with “_sdss0004” is popped into the EX register in line 05 and is used as a base register for accessing columns in the instance record for the routine to be called.

In line 06, the processor address for the instance record is pushed back onto the stack. In line 07 the result of the ADD operation, which is still in register AX, is stored in the instance record in a column associated with the symbol “paramCol1.” The symbol “paramCol1” may be resolved at load-time or earlier depending on the implementation of the execution environment 102. Line 08 shows a call to an SDSS execution environment system routine, “_sdssActivate.” The routine “_sdssActivate” saves register values as required. The routine uses the address of the instance record obtained from the stack to locate the code block record, sets register values enabling the machine code in the code block record to access the instance record, and passes control to the machine code in the code block table record. When control is returned to “_sdssActivate,” any saved registers are restored and control is returned to the code in example 1 at line 09.

Line 10 retrieves the result value placed in the instance record by the called code block record from the instance record column associated with symbol “resultCol”, which may be resolved by a linker at load-time or earlier as discussed in relation to “paramCol”. The result value is loaded into register AX. Line 10 depicts a compare instruction, which compares the result returned from the called code block instance and the result of the ADD instruction in line 01, which was stored in the instance record in the example 1 instruction set as described earlier. The compare operation sets a processor flag indicating whether the values are equal, the first is less the second, or the first is greater than the second.

In line 11 the symbol “_sdss0005” is associated with an instruction location. The linker may determine an SDSS identifier for locating the instruction at least by load-time via the symbol. The SDSS identifier is pushed onto the stack. If the comparison indicates the two operands are equal, processing continues at line 13, which adjusts the stack for the jump not taken. Otherwise, line 12 passes control to an instruction at an execution environment 102 well-known location represented by the symbol “_sdssJump,” which the linker resolves at load-time to the associated processor memory address. SDSS execution environment 102 provides instructions at the location associated with the “_sdssJump” symbol, which pop the SDSS identifier of the desired jump-to location off the stack, locate the code block table and record associated with the identifier, and pass execution control to the machine instruction column of the record located. A compiler, compatible with execution environment 102 placed the “_sdssJump” symbol into its output.

The pseudo-assembly-code in example 2 performs the same function as that shown in example 1. Instead of accessing variables, etc., via SDSS mapped memory, execution environment 102 provided system calls may be used to access addressable object entities stored in SDSS 104, namely, the calls “_sdssGet” and “_sdssPut”. For example, in an arrangement where SDSS 104 includes a DBMS, these calls could be routines inherent to the DBMS. The call architecture differs in example 2 from the previous example for the purpose of illustrating an alternate call architecture. Execution environment 102 calls are generated by the compiler/linker and/or interpreter processes as in example 1, but example 2 uses more calls providing a more indirect access mechanism than the embodiment depicted in example 1. The execution environment 102 provided calls for accessing addressable entities are not in the original source code, unlike example 1 in which addressable entities are accessed by name or by reference. As is the case with example 1, results of function calls are not stored on the stack. Nevertheless, as with example 1, a stack is used for communicating with execution environment 102, again illustrating a mixed execution environment. Finally, like in the case of example 1, the code in this example is running outside of execution environment 102 in a conventional execution environment supported by processor memory 120, accessing addressable entities in the execution environment 102.

### Example 2

| | |
|---|---|
| 01: PUSH | _sdssSym0002 |
| 02: CALL | _sdssGet |
| 03: ADD | [conv0001],AX |
| 04: PUSH | _sdssSym0003+4 |
| 05: PUSH | AX |
| 06: CALL | _sdssPut |
| 07: PUSH | _sdssSym004 |
| 08: PUSH | AX // returned from sdssPut |
| 09: CALL | _sdssActivate |
| 10: L | BX, AX |
| 11: PUSH | _sdssSym0003+4 |
| 12: CALL | _sdssGet |
| 13: CMP | AX,BX |
| 14: PUSH | _sym0005 |
| 15: JNE | _sdssGoTo |
| 16: ADD | SP,2 |

Lines 01-02 retrieve the value of a variable associated with the symbol, “_sdssSym0002” stored in SDSS 104. In example 1 an analogous symbol was “fixed-up” with the processor address. In example 2, the linker replaces the symbol with an SDSS identifier identifying the column where the variables are stored. The execution environment 102 maintains context information for each thread of execution and thus tracks the table identifier and record identifier. The “_sdssGet” execution environment 102 provided routine uses the thread context information and offset to locate the storage location of the variable and returns its value in register AX. The value retrieved is added with the contents of convention processor address represented by the symbol, “conv0001” in line 03. The result, returned in register AX, is stored in a third program variable (lines 04-06). This is accomplished by pushing a column identifier onto the stack and pushing the new value onto the stack, then calling the execution environment routine “_sdssPut,” which uses the thread context to store the value in the table, record, and column indicated.

Lines 07-09 provide instructions for calling a routine associated with the symbol, “_sdssSym004.” The symbol may be replaced by an SDSS identifier identifying a code block table and record. Note that the call is handled differently than in example 1. The identifier of the routine and its parameters are pushed onto the stack (lines 07-08). The execution environment routine “_sdssActivate” is called (line 09). This routine creates a code block instance record, initializes the record using the parameter provided, sets up the thread context for the call allowing the called routine access to the instance record via the “_sdssGet” and “_sdssPut” routines, and calls the indicated routine using the SDSS identifier provided on the stack. The “_sdssActivate” routine places the result of the called routine in register AX, restores the thread context for the calling routine and returns control to line 10. The return result is stored in register BX in line 10.

Lines 11-12 retrieve, using “_sdssGet,” the value stored by lines 04-06. See the description of lines 01-02 above for a description of the “_sdssGet” routine. The retrieved value is stored in register AX when the processing of line 13 begins. Line 13 compares the result of the ADD operation in register BX with the result of the called function in register AX. The remainder of the example is similar to example 1. In line 14 the SDSS identifier of a code block to jump to is pushed onto the stack. In line 15 the processor checks the processor comparison flag. If the flag indicates the two values are equal, processing continues at line 16 where the stack is adjusted for the jump not taken. If the values are equal, a “JNE” instruction passes control to execution environment 102 well-known location (at least to the compiler) represented by “_sdssGoTo,” which locates the instruction using the SDSS identifier provided on the stack, then passes control to the code in the machine code column.

### Advantages of SDSS-Environment-Compatible Tools over Conventional Tools

In contrast to conventional compilers/linker/loaders, the analogous execution environment tools described herein may use the address space (i.e., identifier space 122) and structures supported by an execution environment 102 and may generate object code in which some or all of the program addressable entities may be stored in a structured data store of SDSS 104 and addressed using SDSS identifiers. Once loaded into an SDSS execution environment 102, addressable entities may not need to be unloaded as current programs need to be unloaded from conventional execution environments when execution is complete or the system supporting the execution environment 102 is shutdown. Thus, the SDSS identifiers of addressable object entities may remain fixed, at least for the static or persistent portions of the program, between reboots of the system. Further the relative locations may remain the same allowing references to dynamic instances of addressable object instances to remain fixed once loaded, so re-linking may be minimized, and in some embodiments, eliminated.

In contrast to current compilers, compilers supporting the execution environments described here may produce simpler object files that may be more flexible than conventional object files. In its simplest and purest form, an execution environment object file may be a set of SDSS commands (e.g., DBMS commands or routines) that allocate and store the addressable object code entities specified by the compiled source into storage locations in SDSS 104. Identifiers or partial identifiers for the storage locations to be associated with addressable object code entities may be assigned during the compilation process allowing some linking at this stage, or the assignment of identifiers may be deferred until link, load, or event execution time in some cases.

The compiler used in an execution environment 102 may also provide information relating to program symbols to allow a linker enabled to support the execution environment 102 described herein to link program instructions and data, which reference addressable program entities in the object code or in object code produced from other source code.

An SDSS execution environment compatible compiler may further generate SDSS commands targeted to a particular SDSS implementation. The SDSS commands may be used by a loader to request allocation of storage locations for addressable program entities at load time and to initialize the allocated storage locations. Alternatively, the compiler may generate intermediate information enabling a loader to generate the SDSS commands. In this way, the output of the compiler may be loadable into a number of different types of SDSS execution environments.

Linkers take one or more object files as input and produce a loadable object file or a program object file for a compatible execution environment. Linkers may “fix-up” addresses and offsets to the extent that this can be done prior to loading (some imported symbols may be unresolved until load-time) and may use symbols and associated information allowing the loader and load-time linker to load and “fix-up” the remaining unresolved symbols at load-time or run-time.

In contrast to conventional linkers, which provide “fix-ups” using conventional processor addresses or portions of conventional processor addresses, the SDSS execution environment linkers described herein may use an SDSS identifier or at least a portion of an SDSS identifier to “fix-up” an unresolved reference prior to loading in an object file, at load-time prior to execution, or during execution at run-time. A compatible SDSS loader may load one or more object code files produced as a result of compiling source code addressable entities such that at least a portion of the addressable object entities in the object code file(s) are loaded into SDSS 104 in an execution environment 102. The linker may further identify and prepare references that require resolving at load-time or run-time so that a load-time or run-time linker may resolve the references. As described above, references may be resolved using SDSS identifiers from the SDSS identifier space 122.

As with compilers, the linkers described herein may produce SDSS commands or intermediate data which a loader or subsequently invoked linker instance may later convert to SDSS commands. Accordingly, the object files provided as input to linkers may contain either SDSS commands or intermediate data.

Loaders load program files and program library files to create a program in an execution environment typically using processor accessible memory, virtual and or physical. A loader takes one or more object files and creates a representation of the object file(s) in the execution environment. If any relocation and “fix-ups” are required prior to execution as identified in the object files, a loader relocates instructions and data and a load-time and/or run-time linker performs “fix-ups” of unresolved symbolic references.

In contrast to conventional loaders, SDSS execution environment loaders described herein may use information in an object file to instruct SDSS 104 in an execution environment 102 to allocate storage for one or more addressable entities and optionally initialize one or more of the addressable entities in the associated storage locations.

Persons skilled in the art will understand that the embodiments presented here describing the roles of compiler 106, compiler/interpreter 126, and loader/linker 128 are illustrative and that the functions of these components can be combined to achieve similar operation. Indeed, an interpreter may perform the roles of the compiler, linker, and loader simultaneously.

The executable instructions of a computer program for carrying out the methods described in FIGS. 2, and 10-12 can be embodied in any computer readable medium for use by or in connection with an instruction execution system, apparatus, or device, such as a computer based system, processor containing system, or other system that can fetch the instructions from the instruction execution system, apparatus, or device and execute the instructions. As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

### SDSS-Environment-Compatible Program Instruction

According to another aspect, the subject matter described herein may include a computer program instruction adapted for execution in an execution environment 102. Such an instruction may include an operational code portion and an operand that references an addressable entity. For example, using assembly language as a code example, the operational code instruction may be a jump (or JMP) instruction that instructs the program to jump to a location specified in the operand portion. Normally, the operand of a JMP instruction is a virtual or physical memory address of a processor memory address space. However, according to the subject matter described herein, the operand of the JMP instruction corresponds to an SDSS identifier that references an addressable entity stored in SDSS 104 or, perhaps, references an addressable entity stored at an address corresponding to an SDSS identifier in processor memory 120.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for program execution, the method comprising:
providing an execution environment for a program including a structured data storage system (SDSS) capable of accessing storage locations of a structured data store using corresponding logical identifiers, the data store structured according to a schema known to the SDSS;
allowing an addressable entity of the program to be stored at a storage location of the data store associated with a corresponding logical identifier, the addressable entity stored in conformance with the schema as a result of at least one of compiling a source code representation of the addressable entity, interpreting an intermediate code representation of the addressable entity, linking the addressable entity to other addressable entities, and loading the addressable entity into the execution environment; and
allowing a processor executing a machine code instruction of the program to access the addressable entity using an address corresponding to the logical identifier as an instruction operand during execution of the instruction.

2. The method of claim 1 comprising:
creating or assisting in the creation of an association between the logical identifier and the addressable entity; and
storing and maintaining the association for use during program execution.

3. The method of claim 2 comprising maintaining a processor memory representation of the addressable entity, having a corresponding logical identifier, to provide for a processing of the addressable entity by the processor during execution of the instruction.

4. The method of claim 3 wherein the logical identifier associated with the addressable entity and the logical identifier corresponding to the processor memory representation of the addressable entity form an identifier space for supporting program execution within the execution environment.

5. The method of claim 1 wherein the SDSS comprises a database management system (DBMS).

6. The method of claim 5 wherein the DBMS includes at least one of a relational DBMS, an object-oriented DBMS, a dimensional DBMS, and a hierarchical-model DBMS.

7. The method of claim 6 wherein the data store includes at least one of a relational database an object-oriented database, a dimensional database, and a hierarchical-model database.

8. The method of claim 1 wherein the addressable entity represents at least one of a variable, a constant, a reference, and an instruction of the program.

9. The method of claim 1 wherein allowing a machine code instruction to reference the addressable entity includes allowing a processor to use the SDSS to access the addressable entity in connection with at least one of reading a data value, writing a data value, and executing an instruction stored as the addressable entity in the storage location.

10. The method of claim 1 comprising persistently maintaining links between addressable program entities and logical identifiers, wherein object code referencing the addressable program entities does not have to be re-linked upon subsequent processing of the addressable program entities following a rebooting of a system providing the execution environment.

11. The method of claim 1 comprising providing at least one of a graphical user interface (GUI) and an application programming interface (API) to allow for at least one of:
accessing the addressable entity;
constructing queries related to at least one of the program, the addressable entity, and other related programs; and
managing at least one of the program when linked and loaded into the execution environment, multiple instances of the linked and loaded program, and the addressable entity for each instance of the linked and loaded program.

12. The method of claim 1 wherein the program execution environment allows for use of an address space corresponding to the structured data store that can include a non-sequential virtual address space to support program execution.

13. A system for program execution, the system comprising:
a processor for executing instructions of a program;
a structured data storage system (SDSS) operatively coupled to the processor, the SDSS capable of accessing storage locations of a structured data store using corresponding logical identifiers, the data store structured according to a schema known to the SDSS; and
an execution environment adapted to use the SDSS for execution of the program by the processor, wherein the execution environment:
allows an addressable entity of the program to be stored at a storage location of the SDSS associated with a corresponding logical identifier, the addressable entity stored in conformance with the schema as a result of at least one of compiling a source code representation of the addressable entity, interpreting an intermediate code representation of the addressable entity, linking the addressable entity to other addressable entities, and loading the addressable entity into the execution environment; and
allows the processor executing a machine code instruction to access the addressable entity using an address corresponding to the logical identifier as an instruction operand during execution of the instruction by the processor.

14. The system of claim 13 wherein the SDSS is configured to create or assist in the creation of an association between the logical identifier and the addressable entity and to store and maintain the association for use during program execution.

15. The system of claim 13 wherein the SDSS includes an addressable entity cache configured to maintain a processor memory representation of the addressable entity, having a corresponding logical identifier, to provide for a processing of the addressable entity by the processor during execution of the instruction.

16. The system of claim 15 wherein the logical identifier associated with the addressable entity and the logical identifier corresponding to the processor memory representation of the addressable entity form an identifier space for supporting program execution within the execution environment.

17. The system of claim 13 wherein the SDSS comprises a database management system (DBMS).

18. The system of claim 17 wherein the DBMS includes at least one of a relational DBMS, an object-oriented DBMS, a dimensional DBMS, and a hierarchical-model DBMS.

19. The system of claim 18 wherein the data store includes at least one of a relational database, an object-oriented database, a dimensional database, and a hierarchical-model database.

20. The system of claim 13 wherein the addressable entity represents at least one of a variable, a constant, a reference, and an instruction of the program.

21. The system of claim 13 wherein the execution environment is adapted to use the SDSS for execution of the program by allowing the processor to access the addressable entity when executing the machine code instruction by at least one of reading a data value, writing a data value, and executing an instruction stored as the addressable entity in the storage location.

22. The system of claim 13 wherein the SDSS is adapted to persistently maintain links between addressable program entities and logical identifiers, and wherein object code referencing the addressable program entities does not have to be re-linked upon subsequent processing of the addressable program entities following a rebooting of the system providing the execution environment.

23. The system of claim 13 wherein the execution environment includes at least one of a graphical user interface (GUI) and an application programming interface (API) configured to at least one of:
access the addressable entity;
construct queries related to at least one of the program, the addressable entity, and other related programs; and
managing at least one of the program when linked and loaded into the execution environment, multiple instances of the linked and loaded program, and the addressable entity for each instance of the linked and loaded program.

24. The system of claim 13 wherein the program execution environment allows for use of an address space corresponding to the structured data store that can include a non-sequential virtual address space to support program execution.

25. A method for program execution, the method comprising:
providing an execution environment for a program including a non-sequential address space;
allowing an addressable entity of the program to be stored at a storage location of a data store associated with a corresponding logical identifier, the addressable entity stored as a result of at least one of compiling a source code representation of the addressable entity, interpreting an intermediate code representation of the addressable entity, linking the addressable entity to other addressable entities, and loading the addressable entity into the execution environment; and
allowing a processor executing a machine code instruction of the program to access the addressable entity using an address of the non-sequential address space corresponding to the logical identifier as an instruction operand during execution of the instruction.

26. A system for program execution, the system comprising:
means for executing instructions of a program;
memory access means for accessing storage locations of a structured data store using corresponding logical identifiers, the data store structured according to a schema known to the memory access means;
means for allowing an addressable entity of the program to be stored at a storage location associated with a corresponding logical identifier, the addressable entity stored in conformance with the schema as a result of at least one of compiling of a source code representation of the addressable entity, interpreting of an intermediate code representation of the addressable entity, linking of the addressable entity to other addressable entities, and loading of the addressable entity into the execution environment; and
means for allowing access to the addressable entity during execution of a machine code instruction having an address corresponding to the logical identifier as an instruction operand.

27. A computer-program instruction embodied in a computer-readable medium, the instruction for execution within a program execution environment including a structured data storage system (SDSS) capable of accessing storage locations of a structured data store using corresponding logical identifiers, the data store structured according to a schema known to the SDSS, the instruction comprising:
an operational code portion for instructing a processor to perform a predetermined operation; and
an operand portion including an address corresponding to a logical identifier for referencing an addressable entity stored at a storage location of the SDSS associated with a corresponding logical identifier, the addressable entity stored in conformance with the schema as a result of at least one of compiling a source code representation of the addressable entity, interpreting an intermediate code representation of the addressable entity, linking the addressable entity to other addressable entities, and loading the addressable entity into the execution environment.

28. A computer program product embodied in a computer-readable medium for executing a program in an environment including a structured data storage system (SDSS) capable of accessing storage locations of a structured data store using corresponding logical identifiers, the data store structured according to a schema known to the SDSS, the computer program product comprising instructions for:
allowing an addressable entity of the program to be stored at a storage location of the SDSS associated with a corresponding logical identifier, the addressable entity stored in conformance with the schema as a result of at least one of a compiling of a source code representation of the addressable entity, an interpreting of an intermediate code representation of the addressable entity, a linking of the addressable entity to other addressable entities, and a loading of the addressable entity into the execution environment; and
allowing a processor executing a machine code instruction to reference the addressable entity using an address corresponding to the logical identifier as an instruction operand during execution of the instruction.
